(19) United States
(12) Patent Application Publication
(10) Pub. No.: US 2007/0284390 A1
(43) Pub. Date: Dec. 13, 2007

(54) Reactive mixture with growing molecular species

(76) Inventor: Liang Wang, Acworth, GA (US)

Correspondence Address: LIANG WANG, 2935 WHITEVIEW DRIVE, NW, ACWORTH, GA, 30101, US

(21) Appl. No.: 11/804,900

(22) Filed: May 21, 2007

Related U.S. Application Data
(63) Continuation-in-part of application No. 11/368,132, filed on Mar. 3, 2006.

(51) Int. Cl. B67D 5/00

(52) U.S. Cl. 222/1

(57) ABSTRACT

This invention relates to a method for preparing and dispensing a reactive mixture containing at least a growing molecule species formed by mixing multiple reactive components in a pressurized dispenser with the features of precise ratio, complete mixing, impact-activation, safeguards, leak-proof seal, and self-contained packaging.

### CROSS-REFERENCES TO RELATED APPLICATIONS

U.S. Patent Document 3,251,420 May 17, 1966 Rodgers, et al. 169/77 3,591,089 Jul. 6, 1971 Cronan, 239/304 3,718,235 Feb. 27, 1973 Cronan 222/145 3,773,264 Nov. 20, 1973 Cronan 239/304 3,993,224 Nov. 23, 1976 Harrison 222/135 4,121,772 Oct. 24, 1978 Cronan 239/304 4,377,256 Mar. 22, 1983 Commette 239/117 4,469,252 Sep. 4, 1984 Obrist 222/135 4,593,836 Jul. 10, 1986 Lilienthal 222/136 4,666,062 May 19, 1987 Pershall 222/136 4,801,046 Jan. 31, 1989 Miczka 222/136 4,808,006 Feb. 28, 1989 Kaufeler 222/136 4,969,579 Nov. 13, 1990 Behar 222/136 4,979,638 Dec. 25, 1990 Bolduc 222/1 5,018,643 May 28, 1991 Bolduc 222/1 5,052,585 Oct. 1, 1998 Bolduc 222/1 5,064,121 Nov. 12, 1991 Bolduc 239/309 5,167,347 Dec. 1, 1992 Wiegner, et al. 222/136 5,242,115 Sep. 7, 1993 Brown 239/414 5,332,125 Jul. 25, 1994 Schmitkons, et al. 222/1 5,344,051 Sep. 6, 1994 Brown 222/135 5,405,051 Apr. 11, 1995 Miskell 222/23 5,439,137 Aug. 8, 1995 Grollier et al. 222/1 5,456,386 Oct. 10, 1995 Jesswein 222/136 5,529,245 Jun. 25, 1996 Brown 239/390 5,499,745 Mar. 19, 1996 Derin, at al. 222/136 5,638,992 Jun. 17, 1997 Lim et al. 222/129 6,283,221 Sep. 4, 2001 Hurray et al. 169/30 6,513,729 Feb. 4, 2003 Ochiai, et al. 222/135 6,520,377 Feb. 18, 2003 Yquel 222/1 6,660,325 Dec. 9, 2003 Holfter, et al. 427/121 6,691,898 Feb. 17, 2004 Hurray et al. 222/190 6,755,348 Jun. 29, 2004 Langeman 239/10 6,848,601 Feb. 1, 2005 Greer, Jr 222/136

### OTHER REFERENCES

Studies of Surface Science and Catalysis, Vol. 131, By Dragutan, V. and Streck, R., Catalytic Polymerization of Cycloolefins, Elsevier Science B.V, 2000, Netherlands Modern Fluoropolymers, High Performance Polymers for Diverse Applications, Edited by John Scheirs

### BACKGROUND OF THE INVENTION

1. Field of Invention

This invention relates to a method for preparing and dispensing a reactive mixture including at least a growing molecule species by multiple reactive components from a pressure dispenser with the features of precise ratios, complete mixing, impact-activation, transportation safeguard, and self-contained package. The pressure dispenser comprises a main chamber loaded with the first reactive component and at least an accessory chamber loaded with the second reactive component. Both reactive components are prepared with precise component ratio following an optimum formulation. The accessory chamber is imploded by impacts when dispenser is under vigorous shakes, the reactive components are complete mixed and reacted to form reactive mixture under additional shakes. During the pot life when the nozzle is depressed causing valve to open under propellant pressure, the content is dispensed or sprayed.

2. Cross-Reference to Related Applications

A method for storing and dispensing a final product with pressure dispenser is known art. However, it is unknown that a method for preparing and dispensing a reactive mixture including at least a growing molecule species from a pressure dispenser having features of precise ratio, complete mixing, impact-activation, safeguard, and self-contained package

3. Description of the Related Art

The dispenser including an aerosol can for dispensing a final product is a well-known art. However, a method for preparing and dispensing a reactive mixture including growing molecule species with pressure dispenser having the features of precise ratios, complete mixing, impact-activation, safeguard, and self-contained package is unknown.

Many processes require reactive mixtures instead final products. For example, a reactive mixture of epoxy resin and ammine hardener is prepared for application as an adhesive, and the final product is in a cross-linked solid state product and cannot be applied.

The methods or dispenser devices are known art that are holding plural products in separate containers and are being admixed as they are being discharged. Those “dynamic and continuous flow” methods or devices represent one group of previous arts, such as U.S. Pat. No. 3,993,224, U.S. Pat. No. 4,377,256, U.S. Pat. No. 4,469,252, U.S. Pat. No. 4,801,046, U.S. Pat. No. 4,969,579, U.S. Pat. No. 5,242,115, U.S. Pat. No. 5,270,013, U.S. Pat. No. 5,332,125, U.S. Pat. No. 5,344,051, U.S. Pat. No. 5,529,245, U.S. Pat. No. 5,499,745, U.S. Pat. No. 6,283,221, U.S. Pat. No. 6,513,729, U.S. Pat. No. 6,520,377, U.S. Pat. No. 6,660,325, U.S. Pat. No. 6,691,898 and U.S. Pat. No. 6,755,348.

A precise ratio of reactants is required for complete or total consumption of reactive groups or reactive sites of reactants, based on a functionally equivalent, such as the a ratio for an adhesive made of epoxy-amine, or a paint made of polyol-urethane during cross-linking step. In most cases various catalysts are added for acceleration the reaction rate. In an industrial practice, an optimum component ratio for reactive components to be consumed that is required to form an optimum final product by reactions to achieve the best physical properties for application.

The flow of liquids is viscosity dependent. Viscosity of liquids depends on concentrations of compositions, molecular weight distribution, temperature, velocity of flow, the surface properties of the wall, etc. Industrial interested liquids usually contain multi-components, for example, polymer with broad molecular weight distribution, pigment solids, colloids, etc. The flow behaviors of liquid media with different compositions are very complex function of viscosities. Therefore, it is very difficult even to control an approximate ratio of two components with a simple “dynamic and continuous flow” device. However, the optimum component ratio for multi-component mixture is a key requirement.

Therefore, a complicated precise metering, ratio controlling, monitoring, and compensating system is required to achieve dispensing of multiple component mixture with a “dynamic and continuous flow” device. It may practical and economical only for big scale, ratio closing to 1:1, and repeat applications of few fixed combinations of mixtures with experienced workers. However, “dynamic and continuous flow” methods or devices are not suitable with small touchup jobs due to a lack of precision or too complicated for satisfy a precise component ratio requirement.

A common drawback of “dynamic and continuous flow” methods is the clog problem in the parts where mixed multi-components are passing. A reactive mixture involving solid product or intermediate will adhere to any parts, such as walls, cores, and tubes that contacted with the reactive mixture. For avoid blockage of passage, it is important practice to cleaning all parts of such “dynamic and continuous flow” devices during or after application. It is time consuming and costly.

Other kind of previous arts represent the group with “seal-opening and batch mixing”. U.S. Pat. No. 3,251,420, U.S. Pat. No. 3,591,089, U.S. Pat. No. 3,718,235, U.S. Pat. No. 3,773,264, U.S. Pat. No. 4,121,772, U.S. Pat. No. 4,593,836, U.S. Pat. No. 4,808,006, U.S. Pat. No. 4,979,638, U.S. Pat. No. 5,018,643, U.S. Pat. No. 5,052,585 U.S. Pat. No. 5,064,121, U.S. Pat. No. 5,405,051, U.S. Pat. No. 5,439,137, U.S. Pat. No. 5,456,386, and U.S. Pat. No. 5,638,992 represent such “seal broken & batch mixing” devices. However, all those arts are lake of mixing completeness. For satisfy a precise component ratios, all reactive components need to be released into a mixing chamber without residue concentration gradient. In all those inventions, when the seal is opening, the component originally stored in the compartment or container only can be partially released to the mixing chamber. The opened or broken chamber is still hold a part of component on the wall or in the space where complete mixing is impossible due to blocked geometry.

U.S. Pat. No. 3,251,420, U.S. Pat. No. 3,591,089, U.S. Pat. No. 3,718,235 and U.S. Pat. No. 3,773,262 have a common drawback that is lack of seal hermetization of the inner container for second component, lack of safeguard for transportation and accidental collisions, and redundant non-functional parts.

U.S. Pat. No. 4,121,772 has the drawback of complicated and redundant cylindrical cartridge member and an integral plastic member to mount the secondary container. The lack of seal hermetization is a major problem.

U.S. Pat. No. 4,593,836 used a displaceable plug for actuate “open seal”. However, sealing surrounding the removable plug is difficult due to where the sealing element is always contacting with liquid phase propellant and solvents. For reducing the leaking of contents, sealing material must made of expensive perfluorinated elastomer.

U.S. Pat. No. 4,666,062 and U.S. Pat. No. 5,167,347 is lack of completion of release and mixing of two components.

U.S. Pat. No. 4,808,006 is lack of seal hermetization of movable rod. The drawback is lack of completely release of second component.

U.S. Pat. No. 5,405,051 used a piercing tube which has same drawback due to sealing requirement as U.S. Pat. No. 4,693,836.

U.S. Pat. No. 5,456,386 is lack of safeguard for collisions. The inner container may be separated from the sealing position by an accidental collision. Other drawback is the lack of completion of mixing of two components.

U.S. Pat. No. 4,979,638, U.S. Pat. No. 5,018,643, U.S. Pat. No. 5,052,585 and U.S. Pat. No. 5,064,121 used transparent external containers. Glass is fragile. Transparent plastic is fragile, low mechanical strength, and liable by attacked with propellants and organic solvents. Glass and plastics are not suitable for pressured containers for external package. Other common drawbacks in those inventions are push rods which were used to break ampoule, and are difficult being sealed under pressure.

U.S. Pat. No. 5,439,137 and U.S. Pat. No. 5,638,992 use the pressure releasing in outside chamber to produce a positive pressure in inner chamber and than to “open the seal”. The drawback in those devices is that substantial propellant and materials would be lost before the “open seal” could occur. The amount of released material required is multi parameter dependent variable, such as temperature, composition molar ratio, partial pressure of each component. To keep a precise ratio of two components become impossible.

U.S. Pat. No. 6,848,601 used two containers with a coupler to mix two components. It is not self-contained under the means for each container. It has safeguard advantage. This design has a disadvantage of difficult to operation by un-trained user, and double the manufacture cost compare to single device. It is only justified for high risk products that require 100% guarantee of no admixing of two components, such as two component explosive for deactivation of mines for professionals.

4. Objects and Advantages

Accordingly an object of this invention is to provide a storing means for plural reactive components prior to mix in a pressure dispenser as a reservoir by storing plural reactive components with precise optimum component ratios loaded in separate compartments and maintained separately from one another until ready for use.

Another object of this invention is to provide a complete mixing means by a easily activation method, to achieve a complete release and mix of reactive components in the pressure dispenser, to implement an activation of releasing, mixing, and reacting plural reactive components originally stored in separate compartments prior to use.

Another object of this invention is to provide a preparing means of reactive mixture with complete release and mix of reactive components in the pressure dispenser as a mixer and reactor for mixing and reacting plural reactive components originally stored in separate compartments prior to use.

A further object of the invention is to provide a dispensing means for reactive mixture with optimum component ratios containing growing molecule species prepared in pressure dispenser as dispenser means to discharge reactive mixture with easy operation.

A still further object of the invention is to provide an aerosol spraying means for reactive mixture prepared in pressure dispenser as aerosol spraying means to spraying reactive mixture with optimum component ratios containing growing molecular species.

A still further object of the invention is to provide a safeguard means for pressure dispenser as a dispenser for preparing and dispensing reactive mixture with optimum component ratios containing growing molecule species to avoid non-intention activation of admix of reactive components originally stored in separate compartments during the transportation or accidental collisions.

An important object of the invention is to provide leak-proof seals for compartments loaded with plural reactive components with precise optimum component ratios and maintained separately from one another until ready for use.

5. The Advantages of this Invention are:

(1) To provide a method for preparing and dispensing reactive mixture including at least a growing molecule species.

(2) To provide total release and complete mix of multi reactive components by an inherent advantage of this invention with an implosion of accessory container where the accessory reactive component is originally stored. Following implosion, the wall of the accessory container is totally shattered, therefore, the content of all reactive components are completely mixed. The implosion of accessory container is safe for external wall of pressure container. In the opposite, explosion is danger due to the possibility of broken the external wall of the pressure container.

(3) To provide reliable means to allow reactive components and propellant with precise measured amounts to be loaded in separate plural compartments and containers.

(4) To provide reliable reservoirs for storing separately the reactive components in different compartments prior to mixing of multi reactive components.

(5) To provide easy means for dispensing and spraying reactive mixture with optimum component ratios containing growing molecule species formed in the dispenser under the propellant pressure.

(6) To provide a safeguard for the compartments and containers loaded with reactive components to avoid accidental activation of admixing of reactive components during transportation and accidental collisions.

(7) To providing an easy means for activation the implosion of the accessory container to trigger the mixing and reacting of the multi reactive components.

(8) To integrate all functions, preparing and dispensing in one self-contained package and in portable, hand hold pressure dispenser.

(9) To provide economical manufacture of portable, independent devices for this invention.

(10) To provide leak-proof seals for reservoirs under long time storage of reactive components in different compartments prior to activation for intentional mix of multi reactive components.

### BRIEF SUMMARY OF THE INVENTION

These and other objects and advantages are achieved with present invention that relates to a method for preparing and dispensing a reactive mixture including at least a growing molecule species formed by mixing and reacting multiple reactive components with precise component ratios stored originally in separate chambers of a pressure dispenser with the features of precise ratio, complete mix, impact-activation, safeguard, leak-proof seal, and self-contained package.

This invention relates to a method for preparation and dispensing a reactive mixture containing at least a growing molecule species under ambient temperature in a pressure dispenser comprising a main chamber loaded with the first reactive component and at least an accessory container loaded with the secondary reactive component with an optimum component ratio of reactants, catalyst, additives, and other inertia ingredients required by formulation. Leak-proof seals provide the barrier for avoid the mix of reactive components prior to application. Pre-filled liquefied propellant provides a pressure source in the dispenser. The propellant is dissolved in the first reactive component initially. When the dispenser is under vigorous shakes intentionally, the accessory container is imploded by the impacts. The reactive components are completely mixed and reacted to form reactive mixture containing growing molecular species with optimum component ratios under additional shakes. When the nozzle is depressed causing valve to open under propellant pressure, the content is dispensed. A safeguard design is integrated to avoid the impact activation during transportations or by unintentional accidental collision.

### BRIEF DESCRIPTION OF DRAWING

FIG. 1, FIG. 2, and FIG. 3 show the method of preparation and dispersion of a reactive mixture containing growing molecule species with a pressure dispenser of the present invention.

FIG. 1 illustrates the method by a sectional view of reactive components prepared in precise component ratio and stored in main chamber and accessory container of a pressure dispenser prior to mix and the safeguard feature.

FIG. 2 illustrates the method by a sectional view of complete mixing of reactive components by implosion of the accessory container with vigorous shakes of the pressure dispenser during preparation of the reactive mixture.

FIG. 3 illustrates the method by a sectional view of dispensing reactive mixture containing growing molecular species with the pressure dispenser.

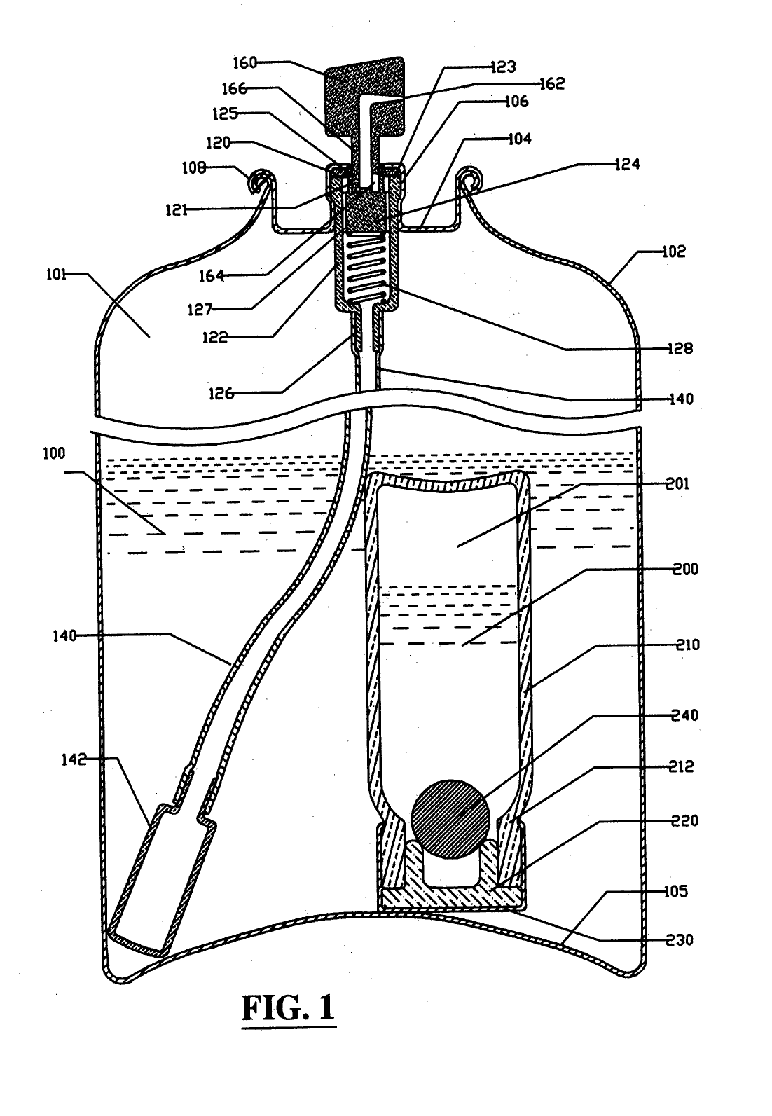

Referring to FIGS. 1, 2 and 3, there is shown the preparation and dispensing a reactive mixture containing at least a growing molecule species by pressure dispenser 102 of present invention.

Referring to FIG. 1, a mixture of the first reactive component and liquefied propellant loaded in the main chamber of pressure dispenser 102 has liquid phase 100, and vapor phase 101, and the second reactive component loaded in accessory chamber, the glass vial 210, has liquid phase 200 and vapor phase 201. Each of reactive components is loaded with precise ratios according to optimum ratios and maintained separately from one another within the main chamber of pressure dispenser 102, and the accessory chamber 210 with a safeguard feature of 220 which prevents the mixing of the said reactive components until activation. The separation between reactive components (100, 101) and (200, 201) in pressure dispenser 102 therein guarantees substantial shelf life since there is no reaction between reactive components (100, 101) and (200, 201) within the pressure dispenser 102 prior to the mixing of the materials.

The reactive mixture 300 containing at least a growing molecule species within pressure dispenser 102 is prepared by vigorous shakes that results the implosion of accessory chamber 210 and mixing of reactive component (100, 101) and (200, 201) immediately prior to use so that at least a growing molecule species is active and the increase of viscosity of reactive mixture is tolerable for dispensing.

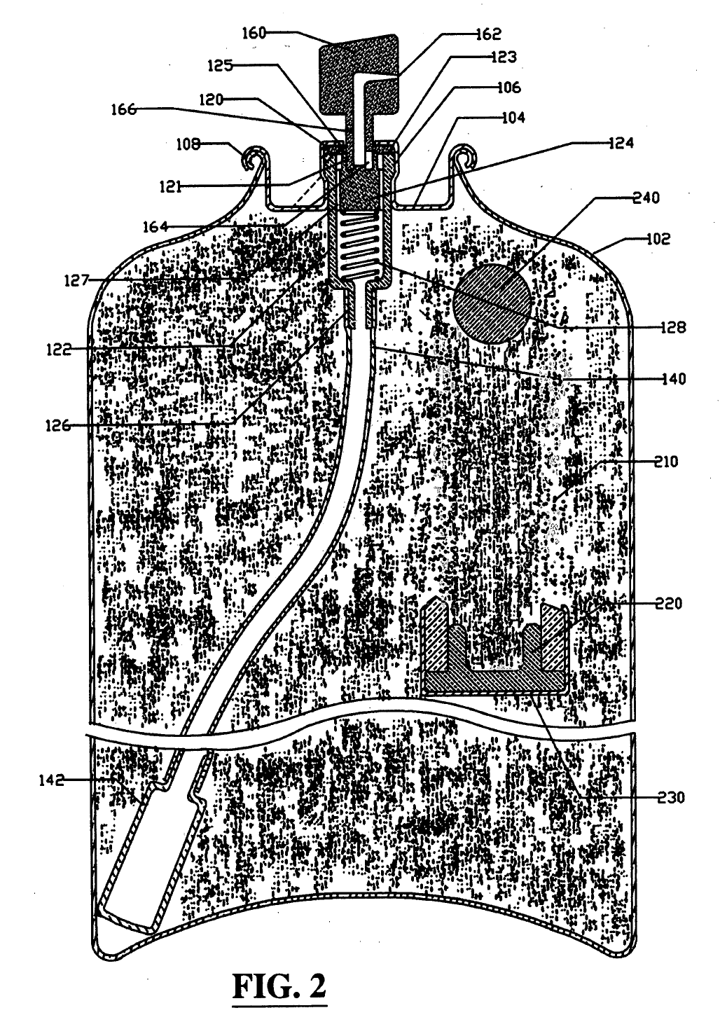

Referring to FIG. 2, the mixing of reactive components is induced by the implosion of said accessory container upon impact with a core element 240 included in said accessory container with vigorous shakes.

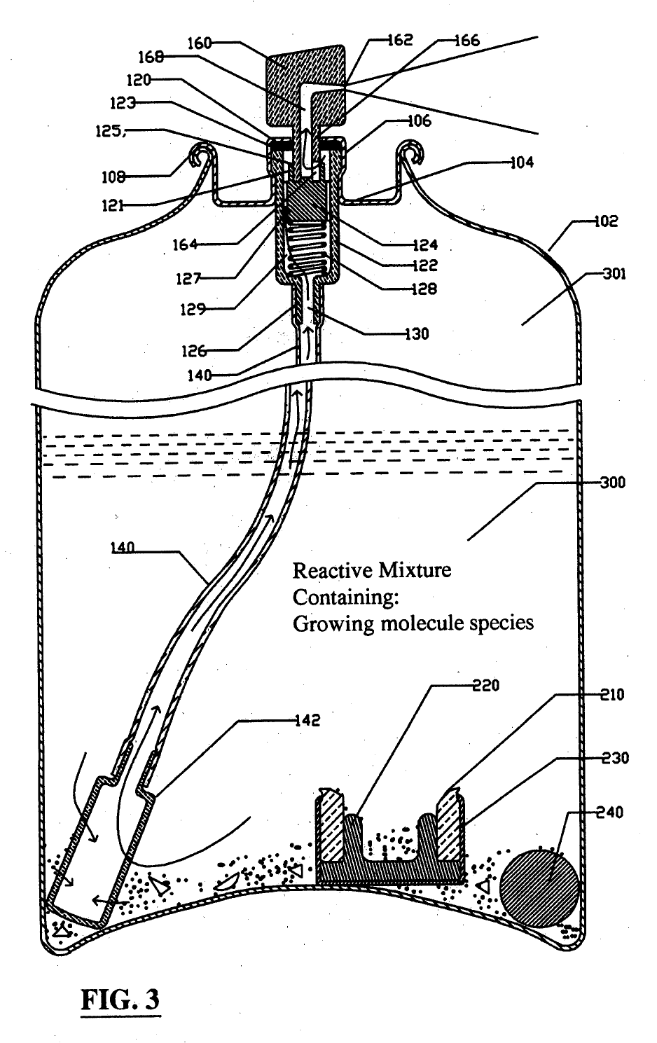

Referring to FIG. 3, the deliver of the mixture 300 of reactive mixture containing growing molecule species and the propellant to a desired location is shown. A combined fill and discharge valve 124 mounted in the valve housing 122 which is sealed with resilient gasket 120 underneath center opening of pedestal 106. When the discharge is actuated the product under propellant pressure is dispensed through the sliding valve core 124, and finally, exiting through the dispenser spout 162.

### DETAILED DESCRIPTION OF THE INVENTION

A broad range of consumer products use dispensers as self-contained package. Those products include one component paints, foams, adhesives, lubricants, insecticides, repellents, foodstuffs, cosmetics, skin-care, hair styles, cleaners, deodorizers, medicine inhaler, personal-defending, tracers, and so on. A typical dispenser is a cylindrical can. A single component product is stored in the can filled with a pressured gas or a liquefied gas. The dispenser has a passage equipped with a shut-off valve connected with a nozzle. When the valve is actuated the product under pressure is dispensed through the valve and exited from the nozzle.

Many applications, however, such as multi component ambient temperature cured paints, adhesives, and foams do not use final products, but apply reactive mixtures with optimum component ratios for achieve an optimum final product. The final products of multi-component coatings, foams, and adhesives are in solid state; therefore, it is impossible to apply.

A self-contained package method for preparing and dispensing reactive mixture with optimum component ratios of multi-components is not commercialized. The inherent problem is the complexity of chemical reactions and reaction kinetics involved. For example, curing reactions in the chemical sense requires a ratio of reactants for total consumption of reactive groups or reactive sites, based on an equivalent functionality, such as for the paint of polyol-urethane, the adhesive of epoxy-amine during hardening step. Catalysts are required to accelerate chemical reactions under ambient temperature at desired reaction rate. The ratio of the amount of catalyst to the specific reactive components is also critical. The optimum component ratios including the ratio of catalyst, and additives to reactive components are required to form a final product with optimum physical properties.

Thousands of brands of polymers, oligomers, cross-linkers, catalysts, and additives are used in industry. All have very different properties, such as the molecular weights, functional group values, and viscosities. For example epoxy resin can react and cure with well over 50 different classes of chemicals, such as amines, polyamides, anhydrides, Lewis acids, ureas, melamine, imidazoles, BF, amine complexes, imides, and so forth. All curing agent has different functionality and require different ratio to reach optimum cure. In addition, catalysts are required for acceleration the reactions for a desired reaction rate. To achieve a desired reaction speed, a precise ratio of specific catalyst to special reactive components is also required. There is no convenient self-contained package and simple dispensing method that can meet the requirements associated for preparing reactive mixture with precise multi-component reactant ratios.

A growing molecule species is a living molecule with active functional group and with feature of the increase of molecule weight in the progress of the time. In the course of time it will convert into a more stable molecule after active function groups reacted. A growing molecule species occur typically during polymerization, oligomerization, cross-linking, colloid gelation, sol-gel networking, and cluster growing reactions. The molecule with functional group or groups, such as monomer, oligomer, and polymer, are growing during chemical reactions. A growing molecule species differ from reactants and products in the way that it is an intermediate molecule that only exists in chemical reaction stages.

During a cross-linking reaction a growing molecule species has the character that molecule weight is increasing and bond network is expending and cross-linking. During cross-link reactions a reactive mixture containing molecular species with growing molecular weight is formed. For example, a multi-component reactive mixture containing molecule species with growing molecular weight of polyol-urethane-catalyst complex is prepared by mixing polyol, urethane and catalyst.

After mixing, hydroxyl groups in polyol are reacting with isocyanato groups in urethane to form urethane bonds under the interacting of metal complex catalyst. A partially reacted polyol molecular has free hydroxyl groups coordinated with metal complex and has sites with cross-linked urethane bonds resulting in the reactions with isocyanato groups when urethane molecules are present. They are chemically reactive. The molecular weights of them are continuously growing. Before all hydroxyl bonds are exhausted, the chemically reactive molecule species are continuously growing, and chemical bond networks are expending until the formation of final cross-linked product.

In chemical sense a stoichiometric ratio of reactants is required for complete or total consumption of reactive groups or reactive sites. In practice, for example, the water molecules exist in other raw materials such as in pigments and in solvents, on the surfaces to be coated and in environmental that also consumes the isocyanato groups of urethane reactant. The ratio of urethane reactant should be higher than the stoichiometric ratio to compensate extra consumption. The precise ratios for reactive components to be consumed are required for an optimum final product with the achievable optimum physical properties. This precise ratio is called optimum component ratio for particular reactant components and determined by experiments.

For forming optimum polyurethane final product an optimum component ratio of polyol/urethane and polyol/catalyst are required. During the preparation of multi component polyurethane paint the reactive mixture with optimum component ratios containing growing molecule species is provided by mixing and reacting polyol, urethane, and metal complex catalyst with precise ratios according to an optimum formulation.

After mixing, a reaction usually undergoes an inductive period with low reaction rate, and then the reaction rate increase progressively. Following the progress of mutual reactions of the functional groups, forming of cross-linked chemical bonds, and growing of molecular weights, the flow viscosity is increasing dramatically. The structural transition occurs from liquid to a gelation and vitrification; and finally becomes solid state which cannot be dissolved or melted. A pot life defines a time span that the mixture is able to flow freely after mixing.

During the pot life the reactive mixture remains low viscosity, and can be dispensed under propellant pressure. The pot life is limited typically within several minutes to several hours. Therefore, it requires maintaining those multiple reactive components in separate containers until desired to admixing. Such reactive components have typically been packaged in separate containers and mixed when just prior to use. During a preparation, reactants, catalysts, pigments, additives, and reactive diluents are precisely weighted or measured separately. The solvents are precisely measured for reaching a desired flow viscosity. Multiple reactive components, catalysts, inertia components, additives, and solvents are mixed thoroughly to forming the reactive mixture ready for applying. Accordingly, they have generally not been suitable for use in the more convenient self-contained package, such as pressure dispensing containers.

Therefore, the main subject of the present invention is a method for preparing and dispensing a reactive mixture with optimum component ratios containing growing molecule species in a pressure dispenser for dispensing or spraying application. More specifically, the invention relates to a method for preparing and dispensing reactive mixture in a pressure dispenser which allows multiple reactive components to be loaded with optimum ratios and stored in separate compartments including at least one accessory container just prior to use. When the time desired for preparing the reactive mixture from multi reactive components with optimum component ratios, intentional vigorous shakes are performed. As result of the impacts, an implosion of the accessory container occurs, the accessory container is shattered, and the component originally stored in the accessory container is totally released into the main chamber and mixed with other reactive components. There is no geometric obstacle to interfere the complete mixing. After mixing and reacting of multi reactive components, the reactive mixture is prepared that can be dispensed under propellant pressure by actuating valve during the product pot life specified flow viscosity. A safeguard design is implemented for avoiding the unintentional impact activation during transportation or accidental collisions.

This invention relates to a method for preparation and dispensing a reactive mixture under ambient temperature in a pressure dispenser comprising a main chamber loaded with the first reactive component and at least an accessory container loaded with the secondary reactive component with an optimum component ratio of reactants, catalyst, additives, and other inertia ingredients required by formulation. When the accessory container is imploded by impacts, the reactive components are mixed and reacted to form an optimum reactive mixture containing growing molecule species. When the nozzle is depressed causing valve to open under propellant pressure, the content is dispensed. A safeguard design is integrated to avoid the impact activation during transportations or by unintentional accidental collision.

This invention relates generally for preparing and dispensing a reactive mixture with optimum component ratios containing growing molecule species in a pressure dispenser as dispenser device for dispensing the reactive mixture containing growing molecule species prepared by mixing and reacting multi reactive components with optimum ratios under ambient temperature, and including the spraying reactive mixture as aerosol generator. This invention is directed to an impact activation of the accessory container that is imploded when desired to initiate the mixing of multi reactive components with precisely prepared, loaded and stored separately in different chambers and containers in the pressurized dispenser. The dispenser is designed for holding at least two reactive components that cannot generally be mixed together until shortly before use. Particularly, the mixing of multi reactive components is activated by impacts when the dispenser is under vigorously shakes by intention. When impacts are executed by intention by vigorous shakes, the accessory container is imploded resulting in the mixing of reactants, catalyst, additives, and other inertia ingredients loaded in multi compartment of the pressure dispenser. This invention provides a means for safeguarding the integrality of the accessory container during long time storage and during transportation to avoid undesired impact activation. This device provides a means for actuate the dispenser and discharging the reactive mixture for use under propellant pressure.

This invention relates to a method for preparation and dispensing of reactive mixture with optimum component ratios containing at least a growing molecule species in a pressure dispenser as a dispenser with the features of impact-activation and transportation safeguard for dispensing and spraying, such as for an aerosol application.

This invention relates to a method to provide leak-proof seal barriers for reservoirs under long time storage of reactive components in different compartments prior to mixing of multi reactive components for preparation and dispensing of reactive mixture with optimum component ratios containing at least a growing molecule species in a pressure dispenser.

In this invention the main chamber of the pressure dispenser is a vessel having a closed bottom wall and an open top. The main chamber has a predetermined diameter.

This invention relates to a method for preparing and dispensing a reactive mixture containing at least a growing molecule species, wherein said reactive mixture results from mixing and reacting between first reactive component and at least a second reactive component, each loaded with a precise ratio and maintained separately within a pressure dispenser having a main chamber, and at least an accessory container with a closure which prevents said mixing of said first reactive component and said second reactive component until an implosion of said accessory container, said method includes:

(a) providing said second reactive component, said second reactive component is loaded in said accessory container, said accessory container is a glass vial loaded with at least one core element, said glass vial is sealed with said closure, said glass vial is placed in said pressure dispenser;

(b) providing said first reactive component, said first reactive component is loaded in said main chamber of said pressure dispenser;

(c) hermetically crimping said pressure dispenser with a mounting cup, said mounting cup having a pedestal mounted with a valve means for filling and discharging;

(d) providing a propellant, said propellant being filled in said pressure dispenser through said valve means, said propellant providing pressure source for said pressure dispenser;

(e) providing reactive mixture with vigorous agitation of said pressure dispenser, said vigorous agitation activating said implosion of said glass vial by physical impact with said core element under said pressure source, said implosion and said agitation which causes said mixing and said reacting of said first reactive component and said second reactive component, and thereby forming said reactive mixture, and

(f) dispensing of said reactive mixture by activating said valve means, thereby dispensing a mixture of said propellant and said reactive mixture from said pressure dispenser under said pressure source.

In this invention the core element included inside said glass vial is selected from the group consisting of a metal pellet, a metal sphere, a metal ellipsoid, a metal cylinder, a metal elliptic cylinder, a metal gear, a metal object, a glass pellet, a glass sphere, a glass ellipsoid, a glass cylinder, a glass elliptic cylinder, a glass gear, a glass object, a glass capillary closed in both ends, a small glass vial, and a mixture thereof.

When the first reactive component contains a polyol macromolecule with multi hydroxy functional groups and the second reactive component contains at least an isocyanate with at least two isocyanato functional groups, the reactions between those two reactive components form at least a growing molecule species containing at least a free hydroxy functional group.

When the first reactive component contains a polyamine macromolecule with multi amino functional groups and the second reactive component contains at least an isocyanate with at least two isocyanato functional groups, the reactions between those two reactive components form at least a growing molecule species containing at least a free amino functional group

When the first reactive component contains an epoxy oligomer with multi epoxy functional groups and the second reactive component contains at least a curing agent, said curing agent is selected from the group consisting of amine, polyamide, anhydride, Lewis acid, urea, melamine, imidazole, BF, amine complex, imide, and a mixture thereof. The reactions between those two reactive components form at least a growing molecule species containing at least a free epoxy functional group.

When the first reactive component contains a molecule with at least a carbon-carbon double bond and the second reactive component includes at least a compound selected from the group consisting of organic peroxide, inorganic peroxide, azo compound, metal alkyl, metathesis catalyst, Bronsted acid, Lewis acid, anionic catalyst, Zeigler-Natta coordination catalyst, organo-metallic compound, metal complex, and a mixture thereof. The reactions between those two reactive components form at least a growing molecule species containing at least a free carbon-carbon double bond.

When the first reactive component contains at least an cyclic olefin, said cyclic olefin is selected from the group consisting of monocyclic olefin, bicyclic olefin, polycyclic olefin, cyclic olefin with ester group, cyclic olefin with nitrile group, cyclic olefin with halogen group, oxygen-containing heterocyclic olefin, nitrogen-containing heterocyclic olefin, silicon-containing heterocyclic olefin and a mixture thereof, and said second reactive component includes at least a compound, said compound is selected from the group consisting of metathesis catalyst, Bronsted acid, Lewis acid, anionic catalyst, Zeigler-Natta coordination catalyst, organo-metallic compound, metal alkyl, metal complex, inorganic peroxide, organic peroxide, azo compound, and a mixture thereof. The reactions between those two reactive components form at least a growing molecule species containing at least a free carbon-carbon double bond.

When the first reactive component contains at least a polysulfide oligomer, and second reactive component includes at least a curing agent, said curing agent is selected from the group consisting of lead dioxide, activated manganese dioxide, calcium peroxide, cumene hydroperoxide, alkaline dichromate, p-quinonedioxime, furfurol, dichlorodiphenol, tine oxide, hydrazine, peperidine, magnesium oxide, sulfoxide, epoxy oligomer, isocyanate, potassium permanganate, zinc oxide, and a mixture thereof. The reactions between those two reactive components form at least a growing molecule species containing at least a free thio functional group.

When the first reactive component contains at least a fibrinogen, and said second reactive component includes at least collagen aggregation enzyme. The reactions between those two reactive components form at least a growing molecule species containing at least a free amino-acid functional group.

When the first reactive component contains at least a phenyldiamine, and second reactive component includes at least a dilute solution of hydrogen peroxide. The reactions between those two reactive components form at least a growing molecule species containing at least a free imino functional group.

When the first reactive component includes at least a dye certified for foods, drugs and cosmetics, said dye certified for foods, drugs and cosmetics is selected from the groups consisting of azo dye, diazo dye, cyanine dye, rhodamine dye, xanthere dye, fluorine dye, anthraquinone dye, triphenylmethane dye, indole dye, indoline dye, chromoionophore, fluoroionophore, melanin dye, and a mixture thereof, and second reactive component includes at least an agent with a functional group, said functional group is selected from the group consisting of thio, thioacetyl, thiobenzoyl, thiocarbamoyl, thiocarbazono, thiocarbodiazono, thiocarbonohydrazido, thiocabonyl, thiocarboxy, thiocyanato, thioformyl, thionoyl, thioreido, thioxo, mercapto, methionyl, acetylcysteine, cysteine, cysteino, cystine, cystino, cysteino, cystamino, epidithio, epithio, isothiocyanato, thioglycolate, thiolacetate, thioglycolate, thiolactate, thioacetyl, thiobenzoyl, thiocarbamoyl, thiocarbazonol, thiocarbodiazonol, and a mixture thereof. The reactions between those two reactive components form at least a growing molecule species containing at least a conjugated double bond chromophore functional group.

The invention includes at least an additional step following or preceding the placement of said glass vial in said pressure dispenser; said additional step is reducing the diameter of the open end of said dispenser to result in a vaulted opening, either through mechanical means or by crimping a vaulted opening on said open end.

This invention includes a method for preparing and dispensing a reactive mixture including at least a growing molecule species, wherein said reactive mixture results from the mixing and reacting between first reactive component, second reactive component, and third reactive component, each loaded with a precise ratio and maintained separately within a pressurized dispenser having a main chamber, and at least one vial with a closure, and a second vial with a second closure, said first closure and second closure preventing said mixing until implosion of said first vial and implosion of said second vial, said method includes;

(a) providing said first reactive component, said first reactive component is loaded in said first vial and loaded with a first core element, said first vial is sealed with said first closure; said first vial is placed in said pressure dispenser with an upside-down orientation;

(b) providing said second reactive component, said second reactive component is loaded in said second vial and loaded with a second core element, said second vial is sealed with said second closure; said second vial is placed in said pressure dispenser with an upside-down orientation;

(c) providing said third reactive component, said third reactive component is loaded in said main chamber of said pressurized dispenser, said pressurized dispenser is hermetically crimped with a mounting cup, said mounting cup having a pedestal mounted with a valve means having a dip tube and filter for filling and discharging;

(d) providing a propellant, said propellant is filled in said pressure dispenser, said propellant providing a pressure source for said pressurized dispenser and stress for said first vial and said second vial;

(e) providing reactive mixture by vigorous agitation of said pressurized dispenser, said vigorous agitation activating said implosion of said first vial by impact with said first core element loaded in said first vial under said stress, and said implosion of second vial by impact with said second core element loaded in said second vial under said stress, said implosions and said vigorous agitation causing said mixing and said reacting of said first reactive component, said second reactive component, and said third reactive component, thereby forming said reactive mixture; and

(f) dispensing said reactive mixture by applying a force to open said valve means, a mixture of said propellant and said reactive mixture including at least a growing molecule species is dispensed from said pressure dispenser under said pressure source.

The invention further including one or more steps following said dispensing reactive mixture including growing molecule species, said step is selected from the group consisting of heating, IR heating, microwave heating, UV irritation, electron beam irritation, grafting reaction, telomerisation reaction, telechelic reaction, chemical modification, and a mixture thereof.

The dispenser is pressure resistant metal dispenser, equipped with an opening and is comprised of a main compartment being loaded with the first reactive component, and at least an accessory container being loaded with the second reactive component. Both the first reactive component and the second reactive component are precisely measured consisting with optimum component ratios. A vaulted metal top having valve housing is hermetically crimped and sealed in the opening of the dispenser. A normally closed shut-off valve connecting with a dispensing nozzle is mounted in the valve housing connecting to the main compartment and having a dipping tube ending with a filter to form a passage.

A measured volume of liquefied propellant is loaded through the normally closed shout-off valve into the dispenser. The second reactive component in the accessory container separates from first reactive component with fluoro-polymer leak-proof seals. Until the accessory container is imploded by impacts with core element included in the accessory container during vigorous shakes, the accessory container is shattered. The first reactive component and the second reactive component are mixed and reacted to form reactive mixture with optimum component ratios containing growing molecule species within the pressure dispenser. Pre-filled repellant gas or liquefied propellant provides a pressure source in the dispenser. The reactive mixture including growing molecule species and dissolved propellant is dispensed through a spout of the nozzle when the nozzle is depressed causing the valve to open.

This invention relates to a method for preparation and dispensing of reactive mixture with optimum component ratios containing growing molecule species in a pressure dispenser as a dispenser. Said pressure dispenser comprises a cylinder can made with metal having a concave bottom wall and a vaulted top or a vaulted top that is crimpled on the cylinder can. The vaulted top can be prepared or can be crimpled on cylinder before the accessory container is placed in the cylinder, if the diameter of the accessory container is less than the diameter of the opening of the vaulted top. If the diameter of the opening of vaulted top is less than the diameter of accessory container, the first step: the accessory container has been placed in the cylinder can, and the next step: the opening of the cylinder can is mechanically shrank to make a vaulted top, or a vaulted top is crimpled on the opening of the cylinder can. The dispenser is designed for holding at least two reactive components that are loaded with optimum component ratios and cannot generally be mixed together until shortly before use. The first reactive component is loaded in the main chamber, and the second reactive component is loaded in accessory container. A vaulted metal top having valve housing is hermetically crimped and sealed in the opening of the dispenser. A shut-off valve connecting with a nozzle is mounted in the top. A propellant is filled in the main chamber of the dispenser as pressure source through a normally closed shut-off valve. The dispensing valve held shut by the propellant pressure inside of the can and a coil spring against a resilient gasket mounted in the valve housing. When impacts are executed by intention with vigorous shakes, the accessory container is imploded and shattered resulting in the complete mixing of reactants, catalyst, additives, and other inertia ingredients in the multi reactive components stored in the can. A reactive mixture with optimum component ratios containing growing molecule species is prepared following implosion of accessory container and mixing of multi reactive components when the dispenser is under vigorously shakes by intention. The valve housing has a dip tube dipping into the bottom of can. A filter is connected at the end of the dip tube. When the valve is actuated the reactive mixture containing growing molecule species under propellant pressure is dispensed through the filter, the dip tube, the valve and exited from the nozzle.

When liquefied propellant and fine spout are used, the reactive mixture with optimum component ratios containing growing molecule species and dissolved propellant is dispensed from a fine spout of the nozzle, the propellant evaporates as soon as the liquid drops of reactive mixture leave the spout, and liquid drops are broken to fine mist aerosol.

These and other objects and advantages of the invention are achieved by using a metal dispenser as the first compartment or main chamber holding, under pressure, the first reactive component to be loaded with a precise amount for an optimum component ratios, and therein an accessory container is included in the main chamber as the second compartment holding the second reactive component to be loaded with a precise component ratios required by optimum formulation to form a reactive mixture. The accessory container as accessory compartment is imploded by multiple impacts by a core element included inside the accessory container, when the dispenser is shaken vigorously by intention. In storage or during transportation, the integrity of said accessory container, the accessory compartment is maintained with a special design for safeguard the secondary compartment, and the reactive components are kept separate from one another with fluoropolymer leak-proof seals. When it is desired to mix, said dispenser is shaken vigorously by intention, the accessory container is imploded and shattered by impacts with a core element included inside said accessory container, and thereafter, the second reactive component is released into the main chamber and mixed and reacted with the first reactive component in the main chamber after said implosion and under vigorous shakes.

In one form of the invention, the accessory chamber is a glass vial having second reactive component with precise component ratios and the core element. The glass vial has an open end having a neck. The open end is plugged by a resilient plug. A fluoropolymer coating layer seals between the resilient plug and the glass vial neck. The resilient plug provides resilient buffer against the impact force on the resilient plug by the core element. The plug is caped on the neck with a thin metal cap. The metal cap holding on the vial neck restricts the plug on the face of vial open end.

In a typical form of the invention, the accessory containers are glass vials. The vial has an open end having a neck. After placing a core element inside the glass vial, a reactive component are loaded, the open end is plugged by a resilient plug. The resilient plug is pre-coated with solvent, chemical and propellant resistant coating or adhesive. The resilient plug with pre-coated coating or adhesive seals the reactive component and the core element. It provides resilient buffer against the impact force on the resilient plug by the core element. After plugging, the coating or adhesive is cured. The cured coating or adhesive forms a permanent seal between the resilient plug and the glass vial. An additional protection is a thin metal cap that caped the solvent and chemical resistant resilient plug on the neck of the vial. The metal cap holding on the vial neck restricts the plug on the face of vial open end. The metal cap minimizes the contact area with the first reactive components and liquefied propellant stored in the main compartment

In other form this invention is to provide a method for preparation and dispensing of reactive mixture with optimum component ratios containing growing molecule species in a pressure dispenser as a dispenser. Said pressure dispenser comprises a cylinder can made with metal having a concave bottom wall and a vaulted top or a vaulted top that is crimpled on the cylinder. The second reactive component is loaded in a glass vial. The vaulted top can be prepared or a vaulted top crimpled on cylinder before the glass vial is placed in the cylinder, if the diameter of the glass vial is less than the diameter of the opening of the vaulted top. If the diameter of the opening of vaulted top is less than the diameter of glass vial, the vaulted top is crimpled after the glass vial has been placed in the cylinder can, or a vaulted top is prepared by mechanical means after the glass vial has placed in the cylinder. The dispenser is designed for holding at least two reactive components that are loaded with optimum component ratios and cannot generally be mixed together until shortly before use.

In other form of this invention the pressure dispense has main compartment being loaded with the first reactive component, and at least two accessory containers, the first accessory container and the second accessory container, being loaded separately with the second reactive component and the third reactive component, and sealed with fluoropolymer coated plugs. All three reactive components are precisely measured and consist with optimum component ratios.

A valve connecting with a nozzle and having valve housing is mounted in the top that control dispensing. The valve housing has a dip tube dipping into the bottom of can. A filter is connected at the end of the dip tube. A measured volume of liquefied propellant is filled into the dispenser through the dispensing valve. The dispensing valve held shut by the pressure inside of the can and a coil spring against a resilient gasket mounted in the valve housing. When impacts are executed by intention with vigorous shakes, the accessory containers are imploded resulting from the impacts of core elements originally inserted in the first accessory and second accessory containers. After implosion and shattering of the first and the second accessory containers, the mixing of all reactive components, including reactants, catalyst, additives, and other inertia ingredients in the multi reactive components stored in the pressure dispenser occur. A reactive mixture with optimum component ratios containing growing molecule species is prepared following implosion and shatter of accessory containers and mixing of multi reactive components when the dispenser is under additional vigorously shakes. When the valve is actuated by applied force with the nozzle depressed, a passage is opened and the reactive mixture containing reactive mixture with optimum component ratios containing growing molecule species is dispensed and exited from the nozzle.

In this invention the glass vial has an open end with at least a core element loaded in said glass vial, said second reactive component is loaded in said glass vial, said open end of said glass vial is thereafter sealed with a closure, said closure is selected from the group consisting of a hermetic glass melt, a plug having at least an O-ring groove with fluoro-elastomer O-ring, a plug coated with fluorinated polymer, a plug having fluorinated surfaces, a plug laminated with fluorinated polymer, a plug having at least an O-ring groove with fluoro-elastomer O-ring and caped with a metal cap, a plug coated with fluorinated polymer and caped with a metal cap, a plug having fluorinated surfaces and caped with a metal cap, a plug caped with metal cap both coated with fluorinated polymer, a plug having fluorinated surfaces and caped with metal cap and then coated with fluoropolymer, a plug coated with fluoropolymer and caped with a metal cap and then coated with fluoropolymer, and a mixture thereof.

In this invention the glass vial has an open end with a screw-thread socket, at least a core element is loaded in said glass vial, said second reactive component is loaded in said glass vial, said open end of said glass vial is thereafter sealed with at least a closure, said closure is selected from the group consisting of a screw-thread cap with a plug having at least an O-ring groove with fluoro-elastomer O-ring, a screw-thread cap with a plug coated with fluorinated polymer, a screw-thread cap with a plug laminated with fluorinated polymer, a screw-thread cap with a fluoro-elastomer O-ring, a screw-thread cap having a gasket laminated with fluorinated polymer, a screw-thread cap with a plug having fluorinated surfaces, and a mixture thereof.

When pressure dispenser having been physically agitated, said core element in response to the given movement changes generates an impact force which impinges upon said glass vial, whereby under multiple impinging cracks being generated and enlarged in said glass vial results in said implosion of said glass vial under said pressure source thereby causing said second reactive component to be released into said main chamber, whereby said growing molecule species is produced as a result of the mixing and reacting of said first reactive component and said second reactive component.

In one typical form of the invention, the accessory containers are glass vials. Each glass vial has an open end having a neck. After placing a core element inside the glass vial, a reactive component is loaded. The open end is plugged by a resilient plug. The resilient plug is pre-coated with solvent, chemical and propellant resistant coating or adhesive. The resilient plug seals the reactive component and the core element. It provides resilient buffer against the impact force on the resilient plug by the core element. After plugging, the coating or adhesive is cured. The cured coating or adhesive forms a permanent seal between the resilient plug and the glass vial. An additional protection is a thin metal cap that caped the solvent and chemical resistant resilient plug on the neck of the vial. The metal cap holding on the vial neck restricts the plug on the face of vial open end. The metal cap minimizes the contact area with the first reactive components and liquefied propellant stored in the main compartment.

The solvent and chemical resistant coating or adhesive is made of the material that provides resilient property and resists the solvent, liquefied propellant and chemicals. Fluorocarbon adhesive, fluorocarbon elastic adhesive, fluorinated coating material curable with cross-linker, UV curable fluorinated coating, Infrared or microwave curable fluorinated coating materials are preferred material choice. Adhesives containing polyvinylidene fluoride, copolymer of vinylidene fluoride and hexafluoropropene, terpolymer of vinylidene-hexafluoropropene-tetrafluoroethylene are preferred adhesive. Adhesives containing copolymer of fluorinated monomer (tetrafluoroethylene or hexafluoropropene or chlorotrifluoroethylene) and vinyl ether or containing copolymer of fluorinated monomer vinyl ester which contains functional groups, such as hydroxy functional groups, in main chain and across-linkable with urethane hardener is preferred. Adhesive containing the copolymer of fluorinated monomer (tetrafluoroethylene or hexafluoropropene or chlorotrifluoroethylene) and vinyl ether or the copolymer of fluorinated monomer and vinyl ester containing unsaturated double bonds cross-linkable by UV or electron beam irritation is also preferred. Adhesive containing fluorinated polymer or fluorinated copolymer with functional groups which curable with hardener under infrared or microwave heating is preferred solvent and propellant resistant adhesive. The fluorinated adhesive, or fluoropolymer coating, or fluorinated surfaces provides leak-proof seal that resists chemicals, solvents and propellant during long time immersion.

The solvent and chemical resistant resilient plugs are made of the elastomer that provide resilient property and resists the solvent, liquefied propellant and chemicals. The resilient plugs are made with chemicals, solvents and propellant resistant material, or laminated or coated with chemical, solvent, and propellant resistant material. Fluorocarbon-elastomer, fluorinated coating, surface fluorinated elastomers, and electric conductive polymer laminated materials are preferred choice. Vinylidene fluoride, vinylidene fluoride/hexafluoropropene copolymer, vinylidene/hexafluoropropene/tetrafluoroethylene terpolymer are commercial available fluorocarbon elastomers. Fluorinated monomer (tetrafluoroethylene or hexafluoropropene or chlorotrifluoroethylene)/vinyl ether copolymer or fluorinated monomer/vinyl ester copolymer cross-linked with urethane hardener is preferred fluorinated coating. Gas phase fluorination of elastomers or plastics provides the surfaces with solvent resistant and solvent permeability barrier. Aluminum or aluminum alloy laminated plugs are solvent and propellant resistant. Solvent or propellant swollen will not occur with fluoro-elastomers, fluorinated coatings, electric conductive polymer or aluminum laminated materials. The solvent and propellant used should no effect on the plug during few years immersion.

An alternative is a resilient plug made of chemical resistant material and has single groove having fluoro-elastomer O-ring in the groove. Other alternative is a resilient plug made of chemical resistant material and has plural O-ring grooves having plural fluoro-elastomer O-rings in the grooves. The O-ring is made of fluoro-elastomer and forms leak-proof seal between the plug and the glass vial neck.

The chemical resistant material for the plug can be selected from cross-linked high-density polyethylene, polypropylene, ethylene-chlorotrifluoroethylene copolymer, ethylene-tetrafluoroethylene copolymer, propylene-chlorotrifluoroethylene copolymer, propylene-tetrafluoroethylene copolymer, fluorinated polyethylene, fluorinated polypropylene, polyvinylidene fluoride, polyvinyl fluoride, polytrifluoroethylene, perfluoropropyl vinyl ether-tetrafluoroethylene copolymer, polymethyl methacrylate, polystyrene, polyvinyl chloride, styrene acrylonitrile, surface fluorinated polyethylene, surface fluorinated polypropylene, surface fluorinated elastomer, polycarbonate, polyetherimide, polyethylene terephthalate copolymer, and polysulfone, fluorinated polyethylene. Aluminum or aluminum alloy laminated high density polyethylene or polypropylene is preferred material choice for organic solvents and propellant resistant application.

The metal cap is made of metal or metal alloy, such as aluminum and aluminum alloy, which resists the chemical corrosions of the reactive components stored in the main chamber. When improved chemical resist is required, a cross-linked fluorinated polymer film is coated on the surfaces of the metal cap for guarantee there is no corrosion or chemical reactions attacking the metal cap. The fluoropolymer coating can be pre applied or applied after the chemical and solvent resistant resilient plug has been caped on the glass vial with the metal cap.

Under typical assembly of the vial, first, the core element is inserted in the vial. The core element can be single or plural. The second, a precisely measured volume of second reactive component is filled in the vial. Finally, the chemical resistant resilient plug with fluoro-elastomer O-ring is plugged on the open end of vial.

Other typical assembly of the vial, first, the core element is inserted in the vial. The core element can be single or plural. The second, a precisely measured volume of second reactive component is filled in the vial. The third, the chemical resistant resilient plug with fluoro-elastomer O-ring is plugged on the open end of vial. Finally, the plug is caped on the neck of the vial with a metal cap.

Under other typical assembly of the vial, first, the core element is inserted in the vial. The core element can be single or plural. The second, a precisely measured volume of second reactive component is filled in the vial. The third, the resilient plug pre-coated with fluorinated polymer is plugged on the open end of vial. The forth, the plug is caped on the neck of the vial with a metal cap. The final, the fluorinated polymer is cured and form a permanent seal between the resilient plug and the glass vial and the metal cap.

Under an assembly of the vial, first, the core element is inserted in the vial, second, a precisely measured volume of second reactive component is filled in the vial, the third, the resilient plug pre-coated with cured fluorinated polymer is plugged on the open end of vial, the forth, the plug is caped on the neck of the vial with a metal cap. The fifth, the vial is inverted and dipped in a fluorinated polymer coating solution until metal cap portion is immersed in the solution. Finally, the fluoropolymer coating is cured. The cured fluorinated polymer forms a chemical protection layer for leak-proof seal.

Under other typical assembly of the vial, first, the core element is inserted in the vial. The core element can be single or plural. Second, a precisely measured volume of second reactive component is filled in the vial. Third, the resilient plug pre-coated with fluorinated polyurethane is plugged on the open end of vial. Forth, the plug is caped on the neck of the vial with a metal cap. The fifth, the fluorinated urethane is cured. The sixth, the vial is inverted and dipped in a fluorinated polymer coating solution until metal cap portion is immersed in the solution. Finally, the fluoropolymer coating is cured. Cured fluorinated polymer forms a chemical protection layer for leak-proof seal.

An example of assembly of the vial, first, the core element is inserted in the vial. The core element can be single or plural. Second, a precisely measured volume of second reactive component is filled in the vial. Third, the resilient plug is coated with fluorinated polyurethane. Before the fluorinated urethane is totally cured, the resilient plug is plugged on the open end of vial. The fluorinated polyurethane is cured and seals the resilient plug surfaces on vial. Finally, the vial is inverted and dipped in a fluorinated polymer coating solution until metal cap portion is immersed in the solution. The cured fluorinated polymer forms a chemical protection layer for leak-proof seal.

Under other assembly of the vial, first, the core element is inserted in the vial, second, a precisely measured volume of second reactive component is filled in the vial, the third, a chemical resistant resilient plug is plugged on the open end of vial, the forth, the plug is caped on the neck of the vial with a metal cap, and finally, the vial is inverted and dipped in a fluorinated polymer coating solution until metal cap portion is immersed in the solution. The fluorinated polymer is cured. The cured fluorinated polymer forms a chemical protection layer for leak-proof seal.

Under other typical assembly of the vial, first, the core element is inserted in the vial, second, the system is evacuated by vacuum, third, a precisely measured volume of second reactive component is filled in the vial under vacuum, the forth, the resilient plug is plugged on the open end of vial under vacuum. The fifth, the plug is caped on the neck of the vial with a metal cap. The final, the vial is inverted and dipped in a fluorinated polymer coating solution until metal cap portion is immersed in the solution. The fluorinated polymer is cured. The cured fluorinated polymer forms a chemical, solvent, and liquefied propellant resistant seal.

Other assembly procedure is practiced. First, the core element is inserted in the vial, second, a precisely measured volume of second reactive component is filled in the vial, the third, the system is evacuated under vacuum, the forth, a chemical resistant resilient plug with fluoro-elastomer O-ring is plugged on the open end of vial under vacuum, and the fifth, the plug is caped with a metal cap on the neck of the vial.

In other form of the invention, the secondary compartment, the accessory container, having second reactive component and a core element, is a glass vial having an open end having a screw-thread neck socket. The side wall of the glass vial is made thicker to resistant the accident fall with side collisions. The open end is plugged by a resilient plug having both faces laminated with fluorinated polymer. The plug is caped on the neck with a screw cap screwed on screw-thread neck socket.

Under typical assembly of the vial, first, the core element is inserted in the vial. The core element can be single or plural. The second, a precisely measured volume of second reactive component is filled in the vial, the third, the resilient plug having fluorinated polymer laminated faces is plugged on the open end of vial, and finally, the plug is caped on the neck with a screw cap screwed on screwed-thread neck socket.

Under typical assembly of the vial, first, the core element is inserted in the vial, second, a precisely measured volume of second reactive component is filled in the vial, the third, the resilient plug is coated with fluorinated polymer and is plugged on the open end of vial, the forth, the plug is caped on the neck with a screw cap screwed on screwed-thread neck socket.

Under other typical assembly of the vial, first, the core element is inserted in the vial, second, the system is evacuated under vacuum, the third, precisely measured volume of second reactive component is filled in the vial under vacuum, the forth, the resilient plug is plugged on the open end of vial, and the plug is caped with a screw cap screwed on. Fifth, the vial is inverted and dipped in a fluorinated polymer coating solution until screwed cap portion is immersed in the solution. The fluorinated polymer coating is cured. The final, cured fluorinated polymer forms a chemical protection layer for leak-proof seal.

Other assembly procedure is practiced. First, the core element is inserted in the vial, second, a precisely measured volume of second reactive component is filled in the vial, the third, the system is evacuated under vacuum, the forth, the resilient plug having fluorinated polymer coated is plugged on the open end of vial under vacuum, and the fifth, the plug is caped with a screw cap. Sixth, the vial is inverted and dipped in a fluorinated polymer coating solution until screw cap portion is immersed in the solution. The fluorinated polymer is cured. The final, cured fluorinated polymer forms a chemical protection layer for leak-proof seal.

After the vial is assembled and fluoropolymer is cured and forms a chemical and solvent resistant seal. The resilient plug with chemical resistant fluoropolymer forms the barrier for safeguard to avoid the mixing between the reactive components before activation of admix. The plug provides resilient buffer for impact force on the resilient plug by the core element. The vial is inverted, the plugged end is faced down to the bottom of the dispenser, and bottom of the vial is faced up when the vial is placed into the dispenser. The height of the vial is made longer than the diameter of the main chamber. After placed inside the dispenser, the vial is kept in upside-down position and is impossible to tip over into a reverse direction.

In singer pressure dispenser the glass vial can be single or plural.

A still a further form of the invention, the secondary compartment having second reactive component and a core element are a glass vial having an open end having a screw-thread neck socket and a chamfer or straight-shoulder on the edge of the neck for contacting with a fluoro-elastomer O-ring for leak-proof seal. The side wall of the glass vial is made thicker to resistant the accident fall with side collisions. The open end can be screwed and sealed with an O-ring or a resilient gasket. The resilient fluoro-elastomer O-ring or gasket can be fitted tightly against the chamfer or straight-shoulder of the edge of the neck with a screw cap screwed on the screw-thread neck socket.

Under typical assembly of the vial, first, the core element is inserted in the vial, second, a precisely measured volume of second reactive component is filled in the vial, the third, fluorinated elastomer O-ring or fluoropolymer laminated or coated resilient gasket is tightly fitted on the edge of open end of vial with a screw cap screwed on the screw-thread neck socket.

Under other typical assembly of the vial, first, the core element is inserted in the vial, second, precisely measured volume of second reactive component is filled in the vial, the third, the resilient fluoro-elastomer O-ring or gasket is fitted on the open end of vial with a screw cap screwed on the screw-thread neck socket.

Other procedure is practiced. First, the core element is inserted in the vial, second, a precisely measured volume of second reactive component is filled in the vial under vacuum, the third, the fluoro-elastomer O-ring or resilient gasket is fitted on the open end of vial with a screw cap screwed on the screw-thread neck socket. The fluoro-elastomer O-ring or gasket seals the second reactive component and the core element. The vial is inverted. The caped end is faced down to the bottom of the dispenser, and bottom of the vial is faced up when the vial is placed into the dispenser. Since the height of the vial is made longer than the diameter of the main chamber. After placed inside the dispenser the vial is kept in upside-down position and is impossible to tip over into a reverse direction.

When the ratio of second reactive component to first reactive component is close to 1:1, a vial with big diameter would be used and it cannot insert through the vaulted top. For assemble, first the vial with big diameter is inserted in the dispenser cylinder with the vial caped end faced down, then, a vaulted top is crimpled on the cylinder can. Other method is to place the vial to a metal cylinder can, and then a vaulted top is prepared by mechanical means.

The core element that is enclosed inside the vial is selected from the group consisting of a metal pellet, a metal sphere, a metal ellipsoid, a metal cylinder, a metal elliptic cylinder, a metal gear, a glass pellet, a glass sphere, a glass ellipsoid, a glass cylinder, a glass elliptic cylinder, a glass gear, a glass capillary closed in both end, a small glass vial, and a mixture thereof.

The core element in a single vial can be single or plural.

The core element that is enclosed inside the vial can be selected from a small vial with same design but with smaller dimension, shorter height, and thicker glass thickness than the vial inserted in.

Said the small vial as core element with same design as the vial inserted in can used to store a third reactive component with smaller volume than the second reactive component.

Said small vial has a chemical resistant plug to seal the third reactive component and the plug is caped with metal cap. Said chemical resistant plug is made of fluorinated elastomer, or elastomer laminated with fluorinated polymer, or elastomer coated with fluorinated polymer, or polymer with fluorinated surfaces.

Other sealing design for small vial is a gasket. The gasket is made of fluorinated elastomer, or fluorinated polymer laminated, or fluoropolymer coated, or surface fluorinated polymer. The gasket is caped with screw cap caped on a screw-thread neck socket of the small vial.

Additional sealing design for small vial is a fluoro-elastomer O-ring seal in screw cap screwed on screw-thread neck socket on the small vial.

The small vial has thinner glass wall around the neck or bottom or both the neck and the bottom that provides a weak mechanical portion which can be broken by impact when it collides with the vial inserted in by vigorous shaken. The third reactive component is mixed with second reactive component when the neck or the bottom of the small vial is broken by collision with the vial inserted when the dispenser is under vigorous shaken. During further vigorous shakes the broken small vial impacts the accessory vial and caused implosion of the accessory vial. The contents inside of accessory vial is released into the main chamber

In other form this invention is to provide a method for preparation and dispensing of reactive mixture with optimum component ratios containing growing molecule species in a pressure dispenser. Said pressure dispenser comprises a cylinder can made with metal having a concave bottom wall and a vaulted top or a vaulted top that is crimpled on the cylinder can. The dispenser is designed for holding at least three reactive components that are loaded with optimum component ratios and cannot generally be mixed together until shortly before use. The pressure dispenser comprises of a main compartment being loaded with the first reactive component with optimum component ratios, and an accessory container, the first accessory container, being loaded with the second reactive component and a smaller vial, the secondary accessory container. Said smaller vial is loaded with third reactive component and inside of second vial. All three reactive components are precisely measured and consist with optimum component ratios. A vaulted metal top having valve housing is hermetically crimped and sealed in the opening of the dispenser. A normally closed shut-off valve connecting with a dispensing nozzle is mounted in the valve housing connecting to the main compartment and having a dipping tube ending with a filter to form a passage. A propellant is filled in the main compartment as pressure source. The dispensing valve held shut by the pressure inside of the can and a coil spring against a resilient gasket mounted in the valve housing.

When impacts are executed by intention with vigorous shakes, the small vial having thinner glass wall around the neck or bottom is broken by impact when collides with the first accessory container inserted in. The third reactive component is mixed with second reactive component when the neck of the small vial is broken by collision with the vial inserted. During further vigorous shakes the broken small vial impacts the first accessory container and caused implosion of the first accessory container. After implosion of the first accessory container, the accessory container is shattered, the broken small vial served as agitator for the mix of all reactive components, including reactants, catalyst, additives, and other inertia ingredients in the multi reactive components stored in the pressure dispenser occurs under additional shakes. A reactive mixture with optimum component ratios containing growing molecule species is prepared following implosion of the first accessory container and mixing of multi reactive components when the dispenser is under vigorously shakes by intention. When the valve is actuated the reactive mixture containing reactive mixture with optimum component ratios containing growing molecule species is dispensed and exited from the nozzle.

The dispensers are packed and placed upright. Inside the dispenser, the vial is kept in upside-down position and is impossible to tip over into a reverse direction, since the height of the vial is made longer than the diameter of the main chamber. When the resilient plug is plugged on vial neck, each core element in dispenser has been rested on the resilient plug. The plug provides resilient buffer for impact force by the core element. The vial having the core element is partial full with secondary reactive component that is in a liquid phase. An empty portion in vial space provides buoyancy in the liquid of the first reactive components. The buoyancy keeps the vial with upside-down position on the bottom of the dispenser regardless the carrier's movements or accidental fall of the package when the dispenser have been packed and stored upright. Impacts by the core element are unable to open the caped plug on the vial. The resilient plug on the open end of the vial is served as a buffer for safeguarding the core element impacts during transportation and accidental fall due to the resiliency of the plug.

When resilient gasket is caped on vial screw-thread socket and the core element has been rested on the resilient gasket. The resilient gasket provides resilient buffer for impact force by the core element. Impacts by the core element are unable to open the caped resilient gasket on the vial. The resilient gasket on the open end of the vial is served as a buffer for safeguarding the core element impacts during transportation and accidental fall due to the resiliency of the resilient gasket.

When resilient screw cap is caped on screw-thread socket, the core element has been rested on the resilient cap. The cap provides resilient buffer for impact force by the core element. Impacts by the core element are unable to open the screw cap on the vial. The resilient cap on the open end of the vial is served as a buffer for safeguarding the core element impacts during transportation and accidental fall due to the resiliency of the membrane.

The sidewall of the vial is made of thicker glass for an additional safeguard to avoid accidental break of the vial by impact that might activate the admixing of reactive components when the dispenser is sideward fell and collided by side.

An additional safeguard may be implemented by a resilient device which has been mounted on the top of the pressure dispenser. The resilient device is comprised of a cap with a resilient material or a resilient annular part of the cap. The resilient device is an additional safeguard for pressure dispenser in the case that impacts occurs when the pressure dispenser is mistakenly packed upside-down during transportation or fall with head of dispenser on the ground.

The accessory container, the vial is made of impact-resistant glass. When the impact force is small, the glass wall of the vial is strong enough to resist the impacts of core element by unintentional collisions.

The glass thickness of bottom of the vial is designed for broken with vigorous shakes by multiple impacts with the core element. When the dispenser is shaken back and forth along approximate longitudinal direction of the dispenser by intention, the maximum movement distance of the core element in the vial can reach the amount of the height of the dispenser minus the thicknesses of vial bottom and the height of the plug. The impact force is equal to the mass of the core element multiplies the acceleration of the traveling core element. If the dispenser is vigorously shaken back and forth along longitudinal direction of the dispenser, the impacts of the core element on vial bottom can make micro cracks in the glass wall. The wall of vial is under the stress of pressure differences of propellant pressure externally and the internal pressure of the vial. Since the pressure of propellant is much high than the pressure of accessory container of second reactive component. The vial wall is under net external stress. Under multiple vigorous impacts the micro cracks grow and the vial is imploded by the implosion under the propellant pressure in the dispenser. When vial is imploded and glass wall is shattered. There is no accessory container would exist after implosion. As result, the reactive component which had kept inside of the vial is completely released into the main chamber. This release is complete, since the original seal, the vial wall is no longer exists. All reactive components are mixed and reacted to from the reactive mixture with optimum component ratios containing growing molecule species in the primary chamber.

The implosion of accessory container, the vial, is one feature that distinguishes with previous inventions. The advantage of the implosion is the completeness of the release of the reactive component which was originally stored inside the accessory container. The completeness of the release provides the completeness of the mixing of all reactive components. No previous art provide such advantage.

A further advantage is the convenience of the activation of the implosion. Vigorous hand shakes easily activate the impacts, and the implosion of the accessory container.

A still further advantage is the security of the integrality of the accessory container that guarantees the safeguard against the transportation and accidental collisions.

A filter is attached in the end of the dip tube. The shattered glass and particles are filtered from the liquid that enters in passage through filter to avoid blocking the passage. A filter is selected from the group consisting of open cell foam, mesh, cloth, textile, woven fabric, nonwoven fabric, porous ceramics, porous glass, and a mixture thereof. Depending on the resistance requirements of reactive components, the material for filter is selected from the group consisting of metal, ceramic, fluorinated polymer, cross-linked polymer, synthetic material, nature material, inorganic material, ceramics, glass, and a mixture thereof.

When the valve is actuated by applied force with depressed nozzle, the passage is open. The propellant pressure pushes the mixture of propellant and reactive mixture to flow through the passage. The mixture passes through the filter, the dip tube, valve housing, valve, nozzle stem, and final, of the nozzle spout or an attached element.

The propellant can be selected from air, nitrogen, oxygen, carbon dioxide, ammonia, dimethyl ether, propane, butane, isobutene, R134, and a mixture thereof.

This invention relates to a method for preparing and dispensing a reactive mixture containing at least a growing molecule species, wherein said reactive mixture results from mixing and reacting between first reactive component and at least a second reactive component, each loaded with a precise ratio and maintained separately within a pressure dispenser having a main chamber, and at least a glass vial with a closure which prevents said mixing of said first reactive component and said second reactive component until an implosion of said glass vial, said method includes:

(a) providing said second reactive component, said second reactive component is loaded in said glass vial, loaded with at least one core element, said glass vial is sealed with said closure, said glass vial is placed in said pressure dispenser;

(b) providing said first reactive component, said first reactive component is loaded in said main chamber of said pressure dispenser;

(c) hermetically crimping said pressure dispenser with a mounting cup, said mounting cup having a pedestal mounted with a valve means for filling and discharging;

(d) providing a propellant, said propellant being filled in said pressure dispenser through said valve means, said propellant providing pressure source for said pressure dispenser;

(e) providing reactive mixture with vigorous agitation of said pressure dispenser, said vigorous agitation activating said implosion of said glass vial by physical impact with said core element under said pressure source, said implosion and said agitation which causes said mixing and said reacting of said first reactive component and said second reactive component, and thereby forming said reactive mixture, and

(f) dispensing of said reactive mixture by activating said valve means, thereby dispensing a mixture of said propellant and said reactive mixture from said pressure dispenser under said pressure source

Present invention is a method for preparing and dispensing a reactive mixture, wherein said the glass vial has a top open end, at least a core element is loaded in said vial, said second reactive component is loaded in said glass vial, said top open end of said glass vial is thereafter sealed with a closure, said closure is selected from the group consisting of a hermetic glass melt, a plug having at least an O-ring groove with fluoro-elastomer O-ring, a plug coated with fluorinated polymer coating, a plug laminated with fluorinated polymer, a plug having at least an O-ring groove with fluoro-elastomer O-ring and a metal cap, a plug and a metal cap and both coated with fluorinated polymer, a plug coated with fluorinated polymer coating and a metal cap, a plug and metal cap both coated with fluorinated polymer, and a mixture thereof.

Present invention is a method for preparing and dispensing a reactive mixture, wherein said glass vial has a top open end with a screw-thread socket, at least a core element is loaded in said glass vial, said second reactive component is loaded in said glass vial, said top open end of said glass vial is thereafter sealed with at least a closure, said closure is selected from the group consisting of a screw-thread cap with a plug having at least an O-ring groove with fluoro-elastomer O-ring, a screw-thread cap with a plug coated with fluorinated polymer coating, a screw-thread cap with a plug laminated with fluorinated polymer, a screw-thread cap with a fluoro-elastomer O-ring, a screw-thread cap having a gasket laminated with fluorinated polymer, and a mixture thereof.

Present invention is a method for preparing and dispensing a reactive mixture, wherein said core element included inside said glass vial is selected from the group consisting of a metal pellet, a metal sphere, a metal ellipsoid, a metal cylinder, a metal elliptic cylinder, a metal gear, a glass pellet, a glass sphere, a glass ellipsoid, a glass cylinder, a glass elliptic cylinder, a glass gear, a glass capillary closed in both end, a small glass vial, and a mixture thereof.

Present invention is a method for preparing and dispensing a reactive mixture, whereby when said pressure dispenser having been shaken back and forth vigorously, said core element in response to the given movement changes generates an impact force whereby impinging upon said glass vial, therewith under multiple impinging cracks being generated and enlarged in said glass vial results in said implosion of said glass vial under said pressure source thereby causing said second reactive component to be released into said main chamber, whereby said growing molecule species is produced as a result of the mixing and reacting of said first reactive component and second reactive component.

In this invention the valve means for filling and discharging includes an encircling gasket, a valve housing, a sliding valve core, a coil spring, a dip tube, a filter, and a nozzle, said valve housing includes an open end and a base with a hollow nipple receiving said dip tube, said filter is mounted to the end of said dip tube, said encircling gasket sealing between said open end of said valve housing and said pedestal of said mounting cup, bottom portion of said sliding valve core receiving said coil spring, upper portion of said sliding valve core receiving a tubular nozzle stem of said nozzle, said sliding valve core held shut with a protruded sealing ring pushed against said encircling gasket by the force of said coil spring compressed between said sliding valve core on one end and against said base of said valve housing on the other end, said tubular nozzle stem has a channel at an end with at least one open groove cut, an alternative of said open groove cut is at least an open orifice being bored into said tubular nozzle stem, said tubular nozzle stem received on said upper portion of sliding valve core;

when force is applied to activate said valve means, said coil spring is compressed further, thereby moving down said nozzle with said tubular nozzle stem, and sliding valve core; said protruded sealing ring on said upper portion of sliding valve core leaves said encircling gasket and said channel on said tubular nozzle stem is uncovered, thereupon a mixture of said propellant and said reactive mixture is conveyed through said filter, said dip tube, said valve housing, said tubular nozzle stem, and exits from said nozzle under said pressure source.

In this invention an other selection for filling and discharging is a valve means that includes an encircling gasket, a valve housing, a sliding valve core, a coil spring, a dip tube, a filter, and a nozzle, said valve housing includes an open end and a base with a hollow nipple receiving said dip tube, said filter is mounted to the end of said dip tube, said encircling gasket seals said open end of said valve housing and said pedestal of said mounting cup, said sliding valve core has an enlarged shoulder and an upper portion with a tubular valve stem adapting a tubular nozzle stem of said nozzle, said tubular valve stem has an elongated hole which terminates at said enlarged shoulder, wherein at least a stem orifice is bored into said elongated hole of said tubular valve stem, and said orifice is located above said enlarged shoulder and serves as a channel, the lower portion of said sliding valve core receiving said coil spring, the upper portion of said sliding valve core has a sealing ring on said enlarged shoulder around said tubular valve stem, said sliding valve core is held shut with said sealing ring on said enlarged shoulder pushed against said encircling gasket by the force of said coil spring compressed between said sliding valve core on one end and against said base of said valve housing on the other end, said tubular nozzle stem is received by said tubular valve stem of said sliding valve core;

when force is applied to open said valve means, said coil spring is compressed further, thereby sliding down said nozzle with said tubular nozzle stem and sliding valve core with tubular valve stem; said sealing ring on said enlarged shoulder of said sliding valve core leaves said encircling gasket and uncovers said channel on said tubular valve stem, thereupon a mixture of said propellant and said reactive mixture including said growing molecule species is conveyed through said filter, said dip tube, said valve housing, said tubular valve stem, said tubular nozzle stem, and exits from said nozzle under said pressure source.

Present invention is related to a method for preparing and dispensing a reactive mixture by a pressure dispenser, wherein said reactive mixture results from mixing and reacting with the first reactive component and at least one second reactive component, each loaded with precise ratios and maintained separately from one another within a main chamber, and at least one accessory container with a closure which prevents the mixing of the said reactive components until activation, which is induced by the implosion of said accessory chamber upon impact with a core element, resulting from vigorous shakes, which aforementioned said reactive mixture is dispensed, and is comprised of any combination of:

(a) A cylindrical can made of metal as said main chamber with a predetermined diameter having a closed bottom and a open top;

(b) A vial made of glass as said accessory container having an open top end with a vial neck and a bottom closed end, said vial having a height longer than said diameter of said cylindrical can;

(c) At least a core element being included inside said vial is selected from the group consisting of a metal bead, a metal sphere, a metal ellipsoid, a metal cylinder, a metal gear, a glass sphere, a glass ellipsoid, a glass cylinder, a glass capillary closed in both end, a small vial, and a mixture thereof;

(d) A second reactive component being loaded in said vial and contributing vapor pressure upon said vial;

(e) A plug as said closure plugging said top open end and sealing said vial neck, said plug is selected from the group consisting of a plug having at least a single O-ring groove with a fluoro-elastomer O-ring, a plug having surfaces coated with fluorinated polymer, a plug having fluorinated surfaces, a plug having surfaces laminated with fluorinated polymer, a plug having surfaces laminated with chemical resistant material, and a mixture thereof;

(f) The vial being placed inside said main chamber with said closure facing said closed bottom of said cylinder can;

(g) The first reactive component being loaded in said main chamber and contributing vapor pressure upon main chamber;

(h) A mounting cup having a pedestal for a valve housing with a center opening at pedestal, and said mounting cup is hermetically crimped in and sealed in said open top of said cylindrical can;

(i) A valve housing having an open end and having base with a hollow nipple receiving a dip tube that extending downward, a filter is mounted to the end of dip tube and approaching to said closed bottom of said cylindrical can for blocking any particles or fragments from flowing into said dip tube, an encircling resilient gasket with a center hole is mounted beneath said pedestal of said mounting cup and attached directly below said center opening at pedestal of said mounting cup, said valve housing is sealed with said open end of said valve housing against said encircling resilient gasket;

(j) A normally shut-off combined fill and discharge sliding valve means having a valve stem, said valve stem having an enlarged shoulder, a tubular upper portion with a elongated hole terminated at said enlarged shoulder, at least a stem orifice being perpendicularly bored into said elongated hole of said tubular upper porting and located above said enlarged shoulder; said enlarged shoulder having sealing face on the upper side, said valve stem having a lower base receiving a coil spring compressed between said lower base on one end and against said base of a valve housing on the other end, thereby said valve means is held shut with sealing face on upper side of enlarged shoulder being pushed against said encircling resilient gasket by the force of said compressed coil spring, and a dispensing nozzle with tubular stem connected with the top of tubular upper portion of valve stem;

(k) At least one liquefied propellant being loaded in said main chamber contributing propellant vapor pressure into total pressure of said main chamber, and said total pressure being equal to the sum of propellant vapor pressure and vapor pressure of said first reactive component in said main chamber, When said pressure dispenser having been shaken back and forth vigorously generally in the direction of the longitudinal axis of said pressure dispenser, said core element in response to the given movement changes of said core element, generates an impact force being equal to the product of the mass of said core element multiplied by the acceleration whereby impinging upon said bottom closed end of said vial, therewith under multiple impinging cracks being generated and enlarged in said vial resulting in said implosion of said vial under the pressure difference of said total pressure in said main chamber minus the internal pressure of said glass vial which results in said implosion of said vial thereby causing said first reactive component and second reactive component to be mixed and to react, thereupon which said growing molecule species is produced under an ambient temperature as a result of the mixing and reacting of said first reactive component and second reactive component, wherein a system pressure of said dispenser is equal to total contributions from said propellant and said growing molecule species, and said reactive component; and

Whereby when force being applied on said dispensing nozzle, said coil spring is compressed further thereupon, said dispensing nozzle with valve stem is thereby depressed down in said valve housing, said sealing face on the upper side of the enlarged shoulder forced leaving said encircling resilient gasket, said stem orifice is uncovered, and said valve means is opened, therein a passage is opened, resulting in said reactive mixture containing growing molecule species and said propellant being conveyed through said passage and passing up said filter, said dip tube, said valve housing, said stem orifice, said upper tubular stem, and said dispensing nozzle during a dispensing operation and causes said dispensing of said mixture from said dispenser under said system pressure.

Other version of present invention is related to a method for preparing and dispensing a reactive mixture containing at least a growing molecule species by a pressure dispenser, wherein said reactive mixture results from mixing and reacting with the first reactive component and at least one second reactive component, each loaded with optimum component ratios and maintained separately from one another within a main chamber, and at least one accessory chamber with a closure which prevents the mixing of the said reactive components until activation, which is induced by the implosion of said accessory chamber upon impact with a core element, resulting from vigorous shakes, which aforementioned said reactive mixture is dispensed, and is comprised of:

(a) A cylindrical can made of metal as said main chamber with height longer than diameter having a closed bottom and a open top;

(b) A vial made of glass as said accessory chamber having an open top end with a screw socket and a bottom closed end, said vial having a height longer than said diameter of said cylindrical can;

(c) At least a core element being included inside said vial is selected from the group consisting of a metal sphere, a metal ellipsoid, a metal cylinder, a metal elliptic cylinder, a metal gear, a glass sphere, a glass ellipsoid, a glass cylinder, a glass elliptic cylinder, a glass gear, a glass capillary closed in both end, a small vial, and a mixture thereof;

(d) The second reactive component being loaded in said vial and contributing vapor pressure upon said vial;

(e) Said closure consisting of a gasket and a screw cap, said gasket plugging said top open end and sealing said vial neck, said gasket is selected from the group consisting of a gasket having at least a single O-ring groove with a fluoro-elastomer O-ring, a gasket having surfaces coated with fluorinated polymer, a gasket having fluorinated surfaces, a gasket having surfaces laminated with fluorinated polymer, a gasket having surfaces laminated with chemical resistant material, and a mixture thereof;

(f) Said screw cap capping over said gasket and keeping said gasket over said top open end and holding onto said screw socket of said vial;

(g) A vial being placed inside said main chamber with said thin metal cap facing said closed bottom of said cylindrical can;

(h) The first reactive component being loaded in said main chamber and contributing vapor pressure upon main chamber;

(i) A mounting cup having a pedestal for a valve housing with a center opening at pedestal and said mounting cup is hermetically crimped in and sealed in said open top of said cylindrical can;

(j) The valve housing having an open end in one end and having base in other end with a hollow nipple receiving a dip tube that extending downward, a filter is mounted to the end of dip tube and approaching to said closed bottom of said cylindrical can for blocking any particles or fragments from flowing into said dip tube, an encircling resilient gasket with a center hole is mounted beneath said pedestal of said mounting cup and attached directly below said center opening at pedestal of said mounting cup, said valve housing is sealed against said encircling resilient gasket at said open end of said valve housing;

(k) A normally shut-off combined fill and discharge valve means having a slide core, down side of said slide core receiving coil spring that is compressed between said slide core on one end and against said base of said valve housing on other end, up side of slide core receiving tubular stem of a dispensing nozzle and having sealing face, said slide core is held shut with said sealing face of said slide core against said encircling resilient gasket by the force of compressed coil spring, said tubular stem of nozzle having a open groove cut or at least an orifice being bored into lower side of said tubular stem, said tubular stem of said dispensing nozzle is received on said slide core;

(l) At least one liquefied propellant being loaded in said main chamber contributing propellant vapor pressure into total pressure of said main chamber, and said total pressure being equal to the sum of propellant vapor pressure and vapor pressure of said first reactive component in said main chamber;

A pressure dispenser for preparing and dispensing a reactive mixture as described above, whereby when said pressure dispenser having been shaken back and forth vigorously generally in direction of the longitudinal axis of said pressure dispenser, said core element in response to the given movement changes of the pressure dispenser relative to said core element, generates an impact force being equal to the product of the mass of said core element multiplied by the acceleration whereby impinging upon said bottom closed end of said vial, therewith under multiple impinging cracks being generated and enlarged in said vial resulting in said implosion of said vial under the pressure difference of said total pressure in said main chamber minus the internal pressure of said glass vial which results in said implosion of said vial thereby causing said first reactive component and second reactive component to be mixed and to react, thereupon which said growing molecule species are produced under an ambient temperature as a result of the mixing and reacting of said first reactive component and second reactive component, wherein a system pressure of said dispenser is equal to total contributions from said propellant and said growing molecule species, and reactive components.

Whereby when said dispensing nozzle being pressed, said slide core is thereby forced down in said valve housing, and said sealing face on the up side of the slide core leaves said encircling resilient gasket and said coil spring is compressed further thereupon said cut groove or orifice is uncovered and said valve means is opened, therein a passage is opened, resulting in said reactive mixture containing growing molecule species and said propellant being conveyed through said passage and passing up said filter, said dip tube, said valve housing, said slide core, said open cut groove or orifice, and said dispensing nozzle during a dispensing operation and causes said dispensing of said mixture from said dispenser under said system pressure.

A still other version of present invention is a method for preparing and dispensing a reactive mixture including at least a growing molecule species, wherein said reactive mixture results from mixing and reacting between one first reactive component and at least one second reactive component, each loaded with a precise ratio and maintained separately within a pressure dispenser having a main chamber, and at least one accessory container with a closure which prevents said mixing of said first reactive component and said second reactive component until an implosion of said accessory container, said method includes:

(a) Providing said second reactive component, said second reactive component is loaded in said accessory container loaded with a core element, said accessory container is sealed with a resilient plug as closure, said resilient plug is coated with fluorinated polymer; said accessory container is placed in said pressure dispenser with an upside-down orientation;

(b) Providing said first reactive component, said first reactive component is loaded in said main chamber of said pressure dispenser, said pressure dispenser is hermetically crimped with a mounting cup, said mounting cup having a pedestal mounted with a combined filling and discharging valve means;

(c) Providing a propellant, said propellant is filled in said pressure dispenser, said propellant providing pressure source for said pressure dispenser and stress on said accessory container;

(e) Providing reactive mixture by vigorous shakes of said pressure dispenser, said vigorous shakes activates said implosion of said accessory container by impacts with said core element under said stress, said implosion and said vigorous shakes causes said mixing and said reacting of said first reactive component and said second reactive component, and thereby forming said reactive mixture, and

(f) Dispensing said reactive mixture by applying a force to open said valve means, a mixture of said propellant and said reactive mixture including growing molecule species is dispensed from said pressure dispenser under said pressure source.

In this invention, wherein said main chamber of said pressure dispenser is a cylindrical can having a closed bottom wall and an open top, said main chamber has a predetermined diameter.

In this method, wherein said accessory container is a glass vial having a top open end with a neck and a bottom closed end, said glass vial has a height longer than said diameter of said main chamber, said second reactive component and said at least a core element is loaded in said glass vial, said top open end of said glass vial is sealed with a closure consisting of a resilient plug with fluorinated polymer coating and a thin metal cap capping said resilient plug over said top open end of said glass vial and holding onto said neck of said glass vial, and said glass vial is placed inside said main chamber with said thin metal cap facing said closed bottom of said pressure dispenser.

In this method, wherein said accessory container is a glass vial having a top open end with a screw-thread socket and a bottom closed end, said glass vial has a height longer than said diameter of said main chamber, said second reactive component and said at least a core element are loaded in said glass vial, said top open end of said glass vial is sealed by a closure, said closure is consisting of a resilient plug and a screw-thread cap, said resilient plug plugging said open end of said glass vial and said resilient plug having fluorinated polymer coated surfaces as said safeguard feature, a screw-thread cap capping said resilient plug over said top open end of said glass vial and holding onto said screw-thread socket of said glass vial, and said glass vial is placed inside said main chamber with said screw-thread cap facing said closed bottom of said pressure dispenser. In this method, wherein said core element included inside said accessory container is selected from the group consisting of a metal sphere, a metal ellipsoid, a metal cylinder, a metal elliptic cylinder, a metal gear, a glass sphere, a glass ellipsoid, a glass cylinder, a glass elliptic cylinder, a glass gear, a glass capillary closed in both end, a small vial, and a mixture thereof. In this method, wherein said filling and discharging valve means includes a encircling gasket, a valve housing, a sliding valve core, a coil spring, a dip tube, a filter, and a nozzle, said valve housing including an open end and a base with a hollow nipple receiving said dip tube, said filter is mounted to the end of said dip tube, said encircling gasket sealing between said open end of said valve housing and said pedestal of said mounting cup, said sliding valve core has blind gear shape, lower portion of said sliding valve core receiving said coil spring, upper portion of said sliding valve core having an protruded adapt ring receiving a tubular nozzle stem of said nozzle, said sliding valve core is held shut with an encircling sealing face on said protruded adapt ring pushed against said encircling gasket by a force of said coil spring compressed between said sliding valve core on one end and against said base of said valve housing on the other end, said tubular nozzle stem has a channel at end with at least one open groove cut, an alternative of said open groove cut is at least an open orifice being bored into said tubular nozzle stem, said tubular nozzle stem received on said protruded adapt ring of said sliding valve core.

In this method, whereby when said force is applied to open said valve means, said coil spring is compressed further, thereby said nozzle with said tubular nozzle stem, and sliding valve core are sliding down, said encircling sealing face on said sliding valve core leaves said encircling gasket and said channel on said tubular nozzle stem is uncovered, thereupon a mixture of said propellant and said reactive mixture including said growing molecule species is conveyed through said filter, said dip tube, said valve housing, said tubular nozzle stem, and exit from said nozzle under said pressure source.

In further another method, wherein said filling and discharging valve means includes a encircling gasket, a valve housing, a sliding valve core, a coil spring, a dip tube, a filter, and a nozzle, said valve housing including an open end and a base with a hollow nipple receiving said dip tube, said filter is mounted to the end of said dip tube, said encircling gasket sealing between said open end of said valve housing and said pedestal of said mounting cup, said sliding valve core has an enlarged shoulder and an upper portion with a tubular valve stem adapting a tubular nozzle stem of said nozzle, said tubular valve stem has an elongated hole terminated at said enlarged shoulder, at least a stem orifice is bored into said elongated hole of said tubular valve stem and located above said enlarged shoulder as a channel, lower portion of said sliding valve core receiving said coil spring, upper portion of said sliding valve core has a sealing ring on said enlarged shoulder around said tubular valve stem, said sliding valve core is held shut with said sealing ring on said enlarged shoulder pushed against said encircling gasket by a force of said coil spring compressed between said sliding valve core on one end and against said base of said valve housing on the other end, said tubular nozzle stem is received with said tubular valve stem of said sliding valve core.

In further method, whereby when said force is applied to open said valve means, said coil spring is compressed further, thereby said nozzle with said tubular nozzle stem, and sliding valve core with tubular valve stem are sliding down, said sealing ring on said enlarged shoulder of said sliding valve core leaves said encircling gasket and said channel on said tubular valve stem is uncovered, thereupon a mixture of said propellant and said reactive mixture including said growing molecule species is conveyed through said filter, said dip tube, said valve housing, said tubular valve stem, said tubular nozzle stem, and exit from said nozzle under said pressure source.

In this method, whereby when said pressure dispenser having been shaken back and forth vigorously, said core element in response to the given movement changes of said core element, generates an impact force whereby impinging upon said accessory container, therewith under multiple impinging cracks being generated and enlarged in said accessory container resulting in said implosion of said accessory container under said stress with said pressure source results in said implosion of said accessory container thereby causing said second reactive component to be released into said main chamber, whereby said growing molecule species is produced as a result of the mixing and reacting of said first reactive component and second reactive component.

In this method, further including a step following said dispensing said reactive mixture, said step is selected from the group consisting of heating, IR heating, microwave heating, UV irritation, electron beam irritation, grafting reaction, telomerisation reaction, telechelic reaction, and chemical modification.

In this invention further includes a method for preparing and dispensing a reactive mixture including at least a growing molecule species, wherein said reactive mixture results from mixing and reacting between one first reactive component, one second reactive component, and one third reactive component, each loaded with a precise ratio and maintained separately within a pressure dispenser having a main chamber, and at least an accessory vial, and a main vial with a closure which prevents said mixing of the reactive components until an implosion of said main vial and broken of said accessory vial, said method includes:

(a) Providing said third reactive component, said third reactive component is loaded in said accessory vial, said accessory vial is contained in said main vial;

(b) Providing said second reactive component, said second reactive component is loaded in said main vial contained with said accessory vial, said main vial is sealed with a resilient plug as said closure; said main vial is placed in said pressure dispenser with an upside-down orientation;

(c) Providing said first reactive component, said first reactive component is loaded in said main chamber of said pressure dispenser, said pressure dispenser is hermetically crimped with a mounting cup, said mounting cup having a pedestal mounted with a combined filling and discharging valve means having a dip tube, and a filter;

(d) Providing a propellant, said propellant is filled in said pressure dispenser, said propellant providing pressure source for said pressure dispenser and stress on said main vial;

(e) Providing reactive mixture by vigorous shakes of said pressure dispenser, said vigorous shakes activates said broken of said accessory vial by impacts with main vial and activates said implosion of said main vial by impacts with said broken accessory vial under said stress, said implosion and said vigorous shakes causes said mixing and said reacting of said first reactive component, said second reactive component, and said third reactive component, and thereby forming said reactive mixture, and

(f) Dispensing said reactive mixture by applying a force to open said valve means, a mixture of said propellant and said reactive mixture including growing molecule species is dispensed from said pressure dispenser under said pressure source.

In this invention also includes a method for preparing and dispensing a reactive mixture including at least a growing molecule species, wherein said reactive mixture results from mixing and reacting between one first reactive component, one second reactive component, and one third reactive component, each loaded with a precise ratio and maintained separately within a pressure dispenser having a main chamber, and at least one first vial with safeguard feature, and one second vial with a safeguard feature which prevent said mixing until implosion of said first vial and implosion of said second vial, said method includes:

(a) Providing said second reactive component, said second reactive component is loaded in said first vial loaded with a first core element, said first vial is sealed with a resilient plug coated with fluoropolymer as said closure; said first vial is placed in said pressure dispenser with an upside-down orientation;

(b) Providing said third reactive component, said third reactive component is loaded in said second vial loaded with a second core element, said second vial is sealed with a resilient plug coated with fluoropolymer as said closure; said second vial is placed in said pressure dispenser with an upside-down orientation;

(c) Providing said first reactive component, said first reactive component is loaded in said main chamber of said pressure dispenser, said pressure dispenser is hermetically crimped with a mounting cup, said mounting cup having a pedestal mounted with a combined filling and discharging valve means having dip tube and a filter;

(d) Providing a propellant, said propellant is filled in said pressure dispenser, said propellant providing pressure source for said pressure dispenser and stress on said first vial and said second vial;

(e) Providing reactive mixture by vigorous shakes of said pressure dispenser, said vigorous shakes activates said implosion of said first vial by impacts with said first core element included in said first vial under said stress, and said implosion of second vial by impacts with said second core element included in said second vial under said stress, said implosions and said vigorous shakes causes said mixing and said reacting of said first reactive component, said second reactive component, and said third reactive component and thereby forming said reactive mixture, and

(f) Dispensing said reactive mixture by applying a force to open said valve means, a mixture of said propellant and said reactive mixture including growing molecule species is dispensed from said pressure dispenser under said pressure source.

### DESCRIPTION OF PREFERRED EMBODIMENTS

Present invention is related to a method for preparing and dispensing a reactive mixture 300 containing at least a growing molecule species by a pressure dispenser 102. Wherein said reactive mixture results from mixing and reacting with the first reactive component 100 (liquid phase in equilibrium with vapor phase 101) and at least one second reactive component 200 (liquid phase in equilibrium with vapor phase 201), each loaded with precise ratios and maintained separately from one another within a main chamber of pressure dispenser 102. At least one accessory container 210 with a closure 220 that is coated with fluoropolymer which provides leak-proof seal. The closure 220 is caped by metal cap 230 that holds the closure 220 on the neck of accessory container 210. The metal cap is optionally coated with fluoropolymer to enhance leak-proof seal. Closure 220 prevents the mixing of the said reactive components (100,101 and 200, 201) until activation, which is induced by the implosion of said accessory container 210 upon impact with a core element 240, resulting from vigorous agitation, which aforementioned said reactive mixture 300 is prepared.

For the purpose of safety and guarantee of pressure resistance, the dispenser 102 has cylindrical shape walls with height longer than diameter. A vaulted top and concave bottom 105 provide pressure resistant advantage. A vaulted bottom also resists pressure, but it requires extra part for stand on shelf. Corrosion resistant metal and alloy, such as steel, aluminum, steel tin-plated is the material choice for pressure dispenser 102.

Referring to FIG. 1, the pressure dispenser 102 is a metal or metal alloy cylindrical can. The main chamber of pressure dispenser 102 has a concave bottom wall 105 and an open top 108.

A vial 210 made of glass as the accessory container has an open top end with a neck 212 and a bottom closed end. The vial 210 has a height longer than the diameter of the cylindrical can of pressure dispenser 102.

At least a core element 240 is included inside said vial 210. The core element 240 is selected from the group consisting of a metal sphere, a metal ellipsoid, a metal cylinder, a metal elliptic cylinder, a metal gear, a glass sphere, a glass ellipsoid, a glass cylinder, a glass elliptic cylinder, a glass gear, a glass capillary closed in both end, a small vial, and a mixture thereof.

The second reactive component 200 with precise amount is loaded in said glass vial 210.

A chemical resistant resilient plug 220 is sealing said second reactive component 200 (liquid phase in equilibrium with vapor phase 201) and has leak-proof seal feature for the operation of pressure dispenser. The resilient plug 220 plugging the top open end of the vial 210, and seal the reactive component 200 in the glass vial 210. Said resilient plug is selected from the group consisting of a plug having at least a single O-ring groove with a fluoro-elastomer O-ring, a plug having surfaces coated with fluorinated polymer, a plug having fluorinated surfaces, a plug having surfaces laminated with fluorinated polymer, a plug having surfaces laminated with chemical resistant material, and a mixture thereof.

The material making the core element 240 is chemical and corrosion resistant for the reactive component 200 stored in the glass vial 210.

The material making the plug 220 must be chemical resistant for the reactive components 100 and 200, and propellant. For long time storage safety with satisfying chemical resistant requirement, the surfaces of the plug 220 either is coated with chemical resistant material, such as fluorinated polymer, or laminated with chemical resistant material, such as fluorinated polymer, or laminated with metals, such as aluminum or aluminum alloy, or chemically treated, such as surface fluorination or having fluorinated surfaces.

Optionally, a thin metal cap 230 is capped over said resilient plug 220. It keeps the resilient plug over the top open end and holds the resilient plug onto the neck 212 of the vial 210. The material making metal cap 230 must be chemical resistant for reactive component 100 and propellant. When necessary, the metal surface is coated with fluorinated polymer.

The loaded vial 210 is placed inside said main chamber of pressure dispenser 102 with the thin metal cap 230 facing the closed bottom 105 of pressure dispenser 102.

The first reactive component with precise amount 100 (liquid phase in equilibrium with vapor phase 101) is loaded in the main chamber of the pressure dispenser 102.

A mounting cup 104 has a pedestal 106 for a valve housing 122 with a center opening at pedestal 106.

If reactive component 100 or propellant is corrosive for metal, the internal surfaces of pressure dispenser 102, the internal surface of mounting cup 104, and metal cap 230 may be coated with chemical resistant polymer. The fluoropolymers have chemical corrosion and solvent resistant properties. Fluoropolymer coated layers on the internal surfaces of metal pressure dispenser 102 and the metal cap 230 provide corrosion and solvent resistance.

A combined fill and discharge valve means mounted in the valve housing 122. The valve housing 122 has an open end 123 and a base with a hollow nipple 126.

An encircling resilient gasket 120 seals between the open end 123 of valve housing 122 and pedestal 106 of the mounting cup104.

The hollow nipple 126 receives a dip tube 140.

A filter 142 is mounted to the end of dip tube 140.

A normally shut-off combined fill and discharge valve means has a sliding valve core 124. The internal wall of valve housing 122 provides the sliding guide for sliding valve core. The gap 127 between valve housing 122 and sliding valve core 124 provides the passage for liquid flow when valve is in opening position.

The down side of sliding valve core receives a coil spring 128. The up side of sliding valve core has a protruded sealing face 125 and a concave adapt ring 121 that receives tubular stem 166 of a dispensing nozzle 160. The sealing face 125 of sliding valve core seals fluid flow when it contacts against the encircling resilient gasket120. The sliding valve core 124 is held shut with the sealing face 125 on the protruded sealing ring 125 of sliding valve core 124 against the encircling resilient gasket 120 by the combined forces of the force of repellant and the force of the coil spring 128 compressed between said sliding valve core 124 on one end and against said base of said valve housing 122 on the other end.

The tubular stem 166 of nozzle 160 has a channel 164 close to the end of the tubular stem with open groove cut. An alternative for the open groove cut is at least an open orifice being bored into said tubular stem 166. The tubular stem 166 of the dispensing nozzle 160 is received on the concave adapt ring 121 of sliding valve core 124.

The mounting cup 104 is hermetically crimped in and sealed in said open top 108 of said cylindrical can of pressure dispenser 102.

At least one propellant is loaded in said main chamber of pressure dispenser 102 that contributing propellant vapor pressure into system pressure. The propellant is filled in the dispenser 102 through the combined fill and discharge valve through the sliding valve core 124 mounted in the valve housing 122 with a specially designed propellant filling machine.

All materials, the first reactive component 100 (liquid phase in equilibrium with vapor phase 101), the second reactive component 200 (liquid phase in equilibrium with vapor phase 201), and the propellant are loaded with high precision by liquid and propellant filling machines having precise volume measurement, constant temperature control, and volume calibration and adjustment to offset the thermal expansions of liquid materials.

The optimum component ratios are the reactive components ratio for complete reactions of reactive groups or reactive sites with an optimized reaction rate under the application temperature for achieving optimum properties of final product which is formed after dispensing of reactive mixture on the target subjects. The formation of a final product requires a reaction time that depend the reaction kinetics. At ambient temperature, the time for completing chemical reactions to form a final product requires from few minutes to few hours after dispersion.

The propellant may be selected from liquefied organic compounds, hydrocarbons, propane, butane, isobutene, dimethyl ether, 1,1,1,2-tetrafluoroethane, carbon dioxide, ammonia, and a mixture thereof.

Under typical assembly of the vial 210, first, the core element 240 is inserted in the vial 210, second, a precisely measured volume of second reactive component 200 is loaded in the vial, the third, the resilient plug 220 is coated with fluorinated polymer and plugged on the open end of vial, and optionally, the plug is caped on the neck 212 of the vial 210 with a metal cap 230.

Under other typical assembly of the vial 210, first, the core element 240 is inserted in the vial 210, second, a precisely measured volume of second reactive component 200 is loaded in the vial under vacuum, the third, a chemical resistant plug 220 having O-ring groove with fluoro-elastomer O-ring is plugged on the open end of vial, and optionally, the plug is caped on the neck 212 of the vial 210 with a metal cap 230.

An additional safeguard is implemented by a dispenser cup which has been mounted on the top of the pressure dispenser 102 but not shown. The dispenser cup is comprised of a cup with a resilient material or a resilient annular part of the cup. The resilient cup-shaped cover is an additional safeguard for pressure dispenser in the case that impacts occurs when the pressure dispenser is packed upside-down during transportation or fall with head of pressure dispenser on the ground.

Under typical assembly of the pressure dispenser, first, the assembled vial is placed in the cylindrical can with the resilient plug 220 facing down the bottom 105 of the cylindrical can. Second, a precisely measured volume of the first reactive component 100 is loaded in the cylindrical can. The third, the assembly of mounting cup 104 with the filling and discharge valve means including encircling resilient gasket 120, valve housing 122, sliding valve core 124, coil spring 128, the dip tube 140, and the filter 142. Said mounting cup is hermetically crimped in and sealed in the open top 108 of the cylindrical can of pressure dispenser 102. The forth, the repellant is filled in the pressure dispenser 102. The nozzle 160 is assembled in the valve housing with the tubular stem 166 of the dispensing nozzle 160 slide in the concave adapt ring 121 of sliding valve core 124. Finally, the dispenser cup is placed over the nozzle and fitted on the top of the pressure dispenser.

When pressure dispensers 102 are packed in the packages, the dispenser 102 is placed upright. Since the vial 210 is placed in the dispenser 102 with the resilient plug 220 facing down to the bottom 105 of the dispenser 102, and the height of the vial 210 is longer than the diameter of the dispenser 102, the orientation of the vial 210 inside of the dispenser cannot change, as the result, the core element 240 inside of vial 210 has been rested on the resilient plug 220. The chemical resistant plug 220 (either with fluoro-elastomer O-ring or with fluorinated polymer coating) seals both the second reactive component 200 and the first reactive component 100 and propellant 101. The vial 210 having the core element 240 is partial full with secondary reactive component 200 that is in a liquid phase. An empty portion in vial space 201 provides buoyancy in the liquid of the first reactive component 100. The buoyancy keeps the vial 210 with upside-down position on the bottom of the dispenser 102 regardless the carrier's movements or accidental fall of the package when the dispenser have been packed and stored upright. Impacts by the core element are unable to open the plug 220 on the vial 210 due to net external pressure on the plug. The resilient plug 220 on the open end of the vial 210 is served as a buffer for safeguarding the impacts of core element 240 during transportation and accidental fall due to the resiliency of the plug.

The sidewall of the vial 210 is made of thicker glass for an additional safeguard to avoid accidental break of the vial by impact that might activate the admixing of reactive components when the dispenser is sideward fell and collided by side.

The accessory container, the vial is made of impact-resistant glass. When the momentum of an impact is small, the glass wall of the vial is strong enough for resisting the core element impacts by unintentional collisions.

FIG. 2 shows the preparation of the reactive mixture containing growing molecular species. When the pressure dispenser is agitated, such as by shaken back and forth approximately along longitudinal direction of the dispenser by intention, the maximum movement distance of the core element 240 in the vial can reach the amount of the height of the dispenser minus the thicknesses of vial bottom and the height of the resilient plug 220. The impact force is equal to the mass of the core element 240 multiplies the acceleration of the core element 240. When the core element changes the direction by impact, the acceleration and the force reaches the maximum. If the dispenser is vigorously shaken back and forth along longitudinal direction of the dispenser 102, the impacts of the core element on vial bottom can make micro cracks in the glass wall.

The wall of vial is under the stress of pressure differences of propellant pressure externally and the vapor pressure of second reactive component internally (solvent provides the major vapor pressure). Since the pressure of propellant is much high than the pressure of second reactive component. The vial wall is under net external stress.

The glass thickness of bottom of the vial is designed for broken with vigorous shakes by multiple impacts with the core element 240. Under multiple vigorous impacts the micro cracks grow and the vial is imploded by the implosion under the propellant pressure in the dispenser.

When vial is imploded and glass wall is shattered as shown in the FIG. 2, the second reactive component which had kept inside of the vial is released into the main chamber. All reactive components are mixed and reacted to from the reactive mixture with optimum component ratios containing growing molecule species in the main chamber.

FIG. 3 shows the dispensing of the reactive mixture containing growing molecular species. After implosion of the glass vial, mixing and reacting of reactive components, the reactive mixture is prepared and ready to be applied as shown in FIG. 2.

The port life of the reactive mixtures is designed by the balance the application convenience and the effectiveness of the reactive mixture. During the port life of the reactive mixture, when a force is applied on the dispensing nozzle 160, the coil spring 128 is compressed further, the sliding valve core 124 is depressed thereby slide down in valve housing 122 as valve slide guide, and the sealing face 125 on the upper side of the protruded sealing ring leaves the encircling resilient gasket 120, the channel 164 with the open cut groove in tubular nozzle stem 166 is uncovered, and therefore, the valve means is opened. A passage is opened.

The filter 142 is an important element. The shattered glass is filtered from the liquid that entering the opened passage for preventing particles blocking passage.

When the passage is opened, the mixture 300 of propellant and the reactive mixture containing growing molecule species are conveyed through said passage under propellant pressure. Said mixture 300 is passing up the filter 142, the dip tube140, the hollow nipple130, the internal space 129 of valve housing, the space 127 between concave gears of sliding valve core 124 and valve housing 122 as sliding valve guide, the channel 164 with open cut groove in nozzle stem 166, and the tubular space 168 in the dispensing nozzle 160, and the finally through the spout 162.

When dispenser is equipped with fine spout 162 and the propellant is a liquefied gas, the product is sprayed as fine drops, as soon as the drops leave the spout 162, drops are broken to form aerosol by the evaporation of the propellant during sudden pressure expansion and causes the dispersing of said mixture from the dispenser.

When dispenser is equipped with an attached pipe and the propellant has relatively low pressure, the product is sprayed as a liquid flow.

The invention further including at least one step following said dispensing reactive mixture including growing molecule species, said step is selected from the group consisting of heating, IR heating, microwave heating, UV irritation, electron beam irritation, grafting reaction, telomerisation reaction, telechelic reaction, chemical modification, and a mixture thereof.

The invention can be applied for multi-component coating material, multi-component adhesives, multi-component paints, multi-component sealer, multi-component dye, and multi-component dental materials, multi-component surgical adhesives, experimental testing materials, multi-component diagnostic materials, multi-component bone restoration materials, multi-component casting and soldering material, multi-component electric materials, and multi-component electronic materials, and etc.

This invention relates to a method for preparation and dispensing of reactive mixture with optimum component ratios containing growing molecule species in a pressure dispenser, wherein said growing molecule species containing at least a free hydroxy functional group, said first reactive component includes at least a macromolecule with at least two hydroxy functional groups, and said second reactive component includes at least an isocyanate with at least two isocyanato functional groups.

This invention relates to a method for preparation and dispensing of reactive mixture with optimum component ratios containing growing molecule species in a pressure dispenser, wherein said growing molecule species containing at least a free amino functional group, said first reactive component includes at least a macromolecule with at least two amino functional groups, and said second reactive component includes at least an isocyanate with at least two isocyanato functional groups.

This invention relates to a method for preparation and dispensing of reactive mixture with optimum component ratios containing growing molecule species in a pressure dispenser, wherein said growing molecule species containing at least a free epoxy functional group, said first reactive component includes at least an epoxy oligomer with at least two epoxy functional groups, and said second reactive component includes at least a curing agent, said curing agent is selected from the group consisting of amine, polyamide, anhydride, Lewis acid, urea, melamine, imidazole, BF, amine complex, imide, and a mixture thereof.

This invention relates to a method for preparation and dispensing of reactive mixture with optimum component ratios containing growing molecule species in a pressure dispenser, wherein said growing molecule species containing at least a free carbon-carbon double bond, said first reactive component includes at least a molecule containing at least a carbon-carbon double bond, and said second reactive component includes at least a substance, said substance is selected from the group consisting of organic peroxide, inorganic peroxide, azo compound, metal alkyl, metathesis catalyst, Bronsted acid, Lewis acid, anionic catalyst, Zeigler-Natta coordination catalyst, organo-metallic compound, metal complex, and a mixture thereof.

This invention relates to a method for preparation and dispensing of reactive mixture with optimum component ratios containing growing molecule species in a pressure dispenser, wherein said growing molecule species containing at least a free carbon-carbon double bond, said first reactive component includes at least an cyclic olefin, said cyclic olefin is selected from the group consisting of monocyclic olefin, bicyclic olefin, polycyclic olefin, cyclic olefin with ester group, cyclic olefin with nitrile group, cyclic olefin with halogen group, oxygen-containing heterocyclic olefin, nitrogen-containing heterocyclic olefin, silicon-containing heterocyclic olefin and a mixture thereof, and said second reactive component includes at least a substance, said substance is selected from the group consisting of metathesis catalyst, Bronsted acid, Lewis acid, anionic catalyst, Zeigler-Natta coordination catalyst, organo-metallic compound, metal alkyl, metal complex, inorganic peroxide, organic peroxide, azo compound, and a mixture thereof.

This invention relates to a method for preparation and dispensing of reactive mixture with optimum component ratios containing growing molecule species in a pressure dispenser, wherein said growing molecular species containing at least a free thio functional group, said first reactive component includes at least a polysulfide oligomer, and second reactive component includes at least a curing agent, said curing agent is selected from the group consisting of lead dioxide, activated manganese dioxide, calcium peroxide, cumene hydroperoxide, alkaline dichromate, p-quinonedioxime, furfurol, dichlorodiphenol, tine oxide, hydrazine, peperidine, magnesium oxide, sulfoxide, epoxy oligomer, isocyanate, potassium permanganate, zinc oxide, and a mixture thereof.

This invention relates to a method for preparation and dispensing of reactive mixture with optimum component ratios containing growing molecule species in a pressure dispenser, wherein said growing molecule species includes at least a free amino-acid group, said first reactive component includes at least a fibrinogen, and said second reactive component includes at least collagen aggregation enzyme.

This invention relates to a method for preparation and dispensing of reactive mixture with optimum component ratios containing growing molecule species in a pressure dispenser, wherein said growing molecular species including at least an imino functional group, said first reactive component includes at least a phenyldiamine, and second reactive component includes at least a dilute solution of hydrogen peroxide.

This invention relates to a method for preparation and dispensing of reactive mixture with optimum component ratios containing growing molecule species in a pressure dispenser, wherein said growing molecular species including at least an conjugated double bond chromophore functional group, said first reactive component includes at least a dye certified for foods, drugs, and cosmetics, said dye certified for foods, drugs, and cosmetics is selected from the groups consisting of azo dye, diazo dye, cyanine dye, rhodamine dye, xanthere dye, fluorine dye, anthraquinone dye, triphenylmethane dye, indole dye, indoline dye, chromoionophore, fluoroionophore, melanin dye, and a mixture thereof, and second reactive component includes at least an agent with a functional group, said functional group is selected from the group consisting of thio, thioacetyl, thiobenzoyl, thiocarbamoyl, thiocarbazono, thiocarbodiazono, thiocarbonohydrazido, thiocabonyl, thiocarboxy, thiocyanato, thioformyl, thionoyl, thioreido, thioxo, mercapto, methionyl, acetylcysteine, cysteine, cysteino, cystine, cystino, cysteino, cystamino, epidithio, epithio, isothiocyanato, thioglycolate, thiolacetate, thioglycolate, thiolactate, thioacetyl, thiobenzoyl, thiocarbamoyl, thiocarbazonol, thiocarbodiazonol, and a mixture thereof.

What is claimed is:

1. A method for preparing and dispensing a reactive mixture containing at least a growing molecule species, wherein said reactive mixture results from mixing and reacting between first reactive component and at least a second reactive component, each loaded with a precise ratio and maintained separately within a pressure dispenser having a main chamber, and at least a glass vial with a closure which prevents said mixing of said first reactive component and said second reactive component until an implosion of said glass vial, said method includes:
(1a) providing said second reactive component, said second reactive component is loaded in said glass vial loaded with at least one core element, said glass vial is sealed with said closure, said glass vial is placed in said pressure dispenser;
(1b) providing said first reactive component, said first reactive component is loaded in said main chamber of said pressure dispenser;
(1c) hermetically crimping said pressure dispenser with a mounting cup, said mounting cup having a pedestal mounted with a valve means for filling and discharging;
(1d) providing a propellant, said propellant being filled in said pressure dispenser through said valve means, said propellant providing pressure source for said pressure dispenser;
(1e) providing reactive mixture with vigorous agitation of said pressure dispenser, said vigorous agitation activating said implosion of said glass vial by physical impact with said core element under said pressure source, said implosion and said agitation which causes said mixing and said reacting of said first reactive component and said second reactive component, and thereby forming said reactive mixture; and
(1f) dispensing of said reactive mixture by activating said valve means, thereby dispensing a mixture of said propellant and said reactive mixture from said pressure dispenser under said pressure source.

2. The method of claim 1, wherein said first reactive component includes at least a molecule with at least two hydroxy functional groups, and said second reactive component includes at least an isocyanate with at least two isocyanato functional groups.

3. The method of claim 1, wherein said first reactive component includes at least a molecule with at least two amino functional groups, and said second reactive component includes at least an isocyanate with at least two isocyanato functional groups.

4. The method of claim 1, wherein said first reactive component includes at least a molecule with at least two epoxy functional groups, and said second reactive component includes at least a curing agent, said curing agent is selected from the group consisting of amine, polyamide, anhydride, Lewis acid, urea, melamine, imidazole, BF, amine complex, imide, and a mixture thereof.

5. The method of claim 1, wherein said first reactive component includes at least a molecule with at least a carbon-carbon double bond, and said second reactive component includes at least a substance, said substance is selected from the group consisting of organic peroxide, inorganic peroxide, azo compound, metal alkyl, metathesis catalyst, Bronsted acid, Lewis acid, anionic catalyst, Zeigler-Natta coordination catalyst, organo-metallic compound, metal complex, and a mixture thereof.

6. The method of claim 1, wherein said first reactive component includes at least an cyclic olefin, said cyclic olefin is selected from the group consisting of monocyclic olefin, bicyclic olefin, polycyclic olefin, cyclic olefin with ester group, cyclic olefin with nitrile group, cyclic olefin with halogen group, oxygen-containing heterocyclic olefin, nitrogen-containing heterocyclic olefin, silicon-containing heterocyclic olefin and a mixture thereof, and said second reactive component includes at least a substance, said substance is selected from the group consisting of metathesis catalyst, Bronsted acid, Lewis acid, anionic catalyst, Zeigler-Natta coordination catalyst, organo-metallic compound, metal alkyl, metal complex, inorganic peroxide, organic peroxide, azo compound, and a mixture thereof.

7. The method of claim 1, wherein said first reactive component includes at least a polysulfide oligomer, and second reactive component includes at least a curing agent, said curing agent is selected from the group consisting of activated manganese dioxide, calcium peroxide, cumene hydroperoxide, alkaline dichromate, p-quinonedioxime, furfurol, dichlorodiphenol, tine oxide, hydrazine, peperidine, magnesium oxide, sulfoxide, epoxy oligomer, isocyanate, potassium permanganate, zinc oxide, and a mixture thereof.

8. The method of claim 1, wherein said first reactive component includes at least a fibrinogen, and said second reactive component includes at least collagen aggregation enzyme.

9. The method of claim 1, wherein said first reactive component includes at least a phenyldiamine, and second reactive component includes at least a dilute solution of hydrogen peroxide.

10. The method of claim 1, wherein said first reactive component includes at least a dye, said dye is selected from the groups consisting of azo dye, diazo dye, cyanine dye, rhodamine dye, xanthere dye, fluorine dye, anthraquinone dye, triphenylmethane dye, indole dye, indoline dye, chromoionophore, fluoroionophore, melanin dye, and a mixture thereof, and second reactive component includes at least an agent with a functional group, said functional group is selected from the group consisting of thio, thioacetyl, thiobenzoyl, thiocarbamoyl, thiocarbazono, thiocarbodiazono, thiocarbonohydrazido, thiocabonyl, thiocarboxy, thiocyanato, thioformyl, thionoyl, thioreido, thioxo, mercapto, methionyl, acetylcysteine, cysteine, cysteino, cystine, cystino, cysteino, cystamino, epidithio, epithio, isothiocyanato, thioglycolate, thiolacetate, thioglycolate, thiolactate, thioacetyl, thiobenzoyl, thiocarbamoyl, thiocarbazonol, thiocarbodiazonol, and a mixture thereof.

11. The method of claim 1, wherein said main chamber of said pressure dispenser is a vessel having a closed bottom wall and an open top, said main chamber has a predetermined diameter.

12. The method of claim 1, wherein said core element included inside said glass vial is selected from the group consisting of a metal pellet, a metal sphere, a metal ellipsoid, a metal cylinder, a metal elliptic cylinder, a metal gear, a metal object, a glass pellet, a glass sphere, a glass ellipsoid, a glass cylinder, a glass elliptic cylinder, a glass gear, a glass object, a glass capillary closed in both ends, a small glass vial, and a mixture thereof.

13. The method of claim 1, wherein said glass vial has an open end with at least a core element loaded in said glass vial, said second reactive component is loaded in said glass vial, said open end of said glass vial is thereafter sealed with a closure, said closure is selected from the group consisting of a hermetic glass melt, a plug having at least an O-ring groove with fluoro-elastomer O-ring, a plug coated with fluorinated polymer, a plug having fluorinated surfaces, a plug laminated with fluorinated polymer, a plug having at least an O-ring groove with fluoro-elastomer O-ring and caped with a metal cap, a plug coated with fluorinated polymer and caped with a metal cap, a plug having fluorinated surfaces and caped with a metal cap, a plug caped with metal cap both coated with fluorinated polymer, a plug having fluorinated surfaces and caped with metal cap and then coated with fluoropolymer, a plug coated with fluoropolymer and caped with a metal cap and then coated with fluoropolymer, and a mixture thereof.

14. The method of claim 1, wherein said glass vial has an open end with a screw-thread socket, at least a core element is loaded in said glass vial, said second reactive component is loaded in said glass vial, said open end of said glass vial is thereafter sealed with at least a closure, said closure is selected from the group consisting of a screw-thread cap with a plug having at least an O-ring groove with fluoro-elastomer O-ring, a screw-thread cap with a plug coated with fluorinated polymer, a screw-thread cap with a plug laminated with fluorinated polymer, a screw-thread cap with a fluoro-elastomer O-ring, a screw-thread cap having a gasket laminated with fluorinated polymer, a screw-thread cap with a plug having fluorinated surfaces, and a mixture thereof.

15. The method of claim 1, whereby when said pressure dispenser having been physically agitated, said core element in response to the given movement changes generates an impact force which impinges upon said glass vial, whereby under multiple impinging cracks being generated and enlarged in said glass vial results in said implosion of said glass vial under said pressure source thereby causing said second reactive component to be released into said main chamber, whereby said growing molecule species is produced as a result of the mixing and reacting of said first reactive component and said second reactive component.

16. The method of claim 1, wherein said valve means for filling and discharging includes an encircling gasket, a valve housing, a sliding valve core, a coil spring, a dip tube, a filter, and a nozzle, said valve housing includes an open end and a base with a hollow nipple receiving said dip tube, said filter is mounted to the end of said dip tube, said encircling gasket sealing between said open end of said valve housing and said pedestal of said mounting cup, bottom portion of said sliding valve core receiving said coil spring, upper portion of said sliding valve core receiving a tubular nozzle stem of said nozzle, said sliding valve core held shut with a protruded sealing ring pushed against said encircling gasket by the force of said coil spring compressed between said sliding valve core on one end and against said base of said valve housing on the other end, said tubular nozzle stem has a channel at an end with at least one open groove cut, an alternative of said open groove cut is at least an open orifice being bored into said tubular nozzle stem, said tubular nozzle stem received on said upper portion of sliding valve core;
whereby when force is applied to activate said valve means, said coil spring is compressed further, thereby moving down said nozzle with said tubular nozzle stem, and sliding valve core; said protruded sealing ring on said upper portion of sliding valve core leaves said encircling gasket and said channel on said tubular nozzle stem is uncovered, thereupon a mixture of said propellant and said reactive mixture is conveyed through said filter, said dip tube, said valve housing, said tubular nozzle stem, and exits from said nozzle under said pressure source.

17. The method of claim 1, wherein said valve means for filling and discharging includes an encircling gasket, a valve housing, a sliding valve core, a coil spring, a dip tube, a filter, and a nozzle, said valve housing includes an open end and a base with a hollow nipple receiving said dip tube, said filter is mounted to the end of said dip tube, said encircling gasket seals said open end of said valve housing and said pedestal of said mounting cup, said sliding valve core has an enlarged shoulder and an upper portion with a tubular valve stem adapting a tubular nozzle stem of said nozzle, said tubular valve stem has an elongated hole which terminates at said enlarged shoulder, wherein at least a stem orifice is bored into said elongated hole of said tubular valve stem, and said orifice is located above said enlarged shoulder and serves as a channel, the lower portion of said sliding valve core receiving said coil spring, the upper portion of said sliding valve core has a sealing ring on said enlarged shoulder around said tubular valve stem, said sliding valve core is held shut with said sealing ring on said enlarged shoulder pushed against said encircling gasket by the force of said coil spring compressed between said sliding valve core on one end and against said base of said valve housing on the other end, said tubular nozzle stem is received by said tubular valve stem of said sliding valve core;
whereby when said force is applied to open said valve means, said coil spring is compressed further, thereby sliding down said nozzle with said tubular nozzle stem and sliding valve core with tubular valve stem; said sealing ring on said enlarged shoulder of said sliding valve core leaves said encircling gasket and uncovers said channel on said tubular valve stem, thereupon a mixture of said propellant and said reactive mixture including said growing molecule species is conveyed through said filter, said dip tube, said valve housing, said tubular valve stem, said tubular nozzle stem, and exits from said nozzle under said pressure source.

18. The method of claim 1, further including at least an additional step following or preceding the placement of said glass vial in said pressure dispenser; said additional step is reducing the diameter of the open end of said dispenser to result in a vaulted opening, either through mechanical means or by crimping a vaulted opening on said open end.

19. The method of claim 1, further including at least an additional step following said dispensing of said reactive mixture; said step is selected from the group consisting of heating, IR heating, microwave heating, UV irritation, electron beam irritation, grafting reaction, telomerisation reaction, telechelic reaction, chemical modification, and a mixture thereof.

20. A method for preparing and dispensing a reactive mixture including at least a growing molecule species, wherein said reactive mixture results from the mixing and reacting between first reactive component, second reactive component, and third reactive component, each loaded with a precise ratio and maintained separately within a pressurized dispenser having a main chamber, and at least one vial with a closure, and a second vial with a second closure, said first closure and second closure preventing said mixing until implosion of said first vial and implosion of said second vial, said method includes;
(20a) providing said first reactive component, said first reactive component is loaded in said first vial and loaded with a first core element, said first vial is sealed with said first closure; said first vial is placed in said pressure dispenser with an upside-down orientation;
(20b) providing said second reactive component, said second reactive component is loaded in said second vial and loaded with a second core element, said second vial is sealed with said second closure; said second vial is placed in said pressure dispenser with an upside-down orientation;
(20c) providing said third reactive component, said third reactive component is loaded in said main chamber of said pressurized dispenser, said pressurized dispenser is hermetically crimped with a mounting cup, said mounting cup having a pedestal mounted with a valve means having a dip tube and filter for filling and discharging;
(20d) providing a propellant, said propellant is filled in said pressure dispenser, said propellant providing a pressure source for said pressurized dispenser and stress for said first vial and said second vial;
(20e) providing reactive mixture by vigorous agitation of said pressurized dispenser, said vigorous agitation activating said implosion of said first vial by impact with said first core element loaded in said first vial under said stress, and said implosion of second vial by impact with said second core element loaded in said second vial under said stress, said implosions and said vigorous agitation causing said mixing and said reacting of said first reactive component, said second reactive component, and said third reactive component, thereby forming said reactive mixture; and
(20f) dispensing said reactive mixture by applying a force to open said valve means, a mixture of said propellant and said reactive mixture including at least a growing molecule species is dispensed from said pressure dispenser under said pressure source.
